(19) United States
(12) Patent Application Publication
(10) Pub. No.: US 2025/0179287 A1
(43) Pub. Date: Jun. 5, 2025

(54) RUBBER COMPOSITION AND TIRE

(71) Applicant: SUMITOMO RUBBER INDUSTRIES, LTD., Kobe-shi, Hyogo (JP)

(72) Inventor: Yamato ICHIMOTO, Kobe-shi (JP)

(73) Assignee: SUMITOMO RUBBER INDUSTRIES, LTD., Kobe-shi, Hyogo (JP)

(21) Appl. No.: 18/843,514

(22) PCT Filed: Feb. 8, 2023
(86) PCT No.: PCT/JP2023/004086

§ 371 Date: Sep. 3, 2024

(30) Foreign Application Priority Data
Mar. 7, 2022 (JP) 2022-034508

(51) Int. Cl. C08L 51/04; B60C 1/00; C08C 19/28; C08C 19/36; C08F 279/06; C08K 3/36; C08K 5/548

(52) U.S. Cl. CPC C08L 51/04; B60C 1/0016; C08C 19/28; C08C 19/36; C08F 279/06; C08K 3/36; C08K 5/548; C08K 2201/005; C08K 2201/011; C08L 2205/025; C08L 2205/035

(57) ABSTRACT

The present disclosure provides a rubber composition and a tire which can suppress changes in performances caused by changes in road conditions from dry to wet road surface or from wet to dry road surface. The tire of the present disclosure has E* when wet with water (MPa), E* when dry (MPa), tan δ when wet with water, tan δ when dry, 40% modulus (MPa) at 70° C. before a tensile test, and 40% modulus (MPa) at 70° C. after the tensile test which satisfy the following formulas (1) to (3):
(1) E* when wet with water/E* when dry ≤0.90
(2) tan δ when wet with water/tan δ when dry >1.00
(3) 40% modulus at 70° C. after tensile test/40% modulus at 70° C. before tensile test ≥0.45 where
   E* and tan δ refer to a complex modulus of elasticity and a loss tangent, respectively, after 30 minutes from the start of measurement under the conditions of a temperature of 30° C., an initial strain of 10%, a dynamic strain of 1%, a frequency of 10 Hz, an elongation mode, and a measurement duration of 30 minutes;
   40% modulus at 70° C. after the tensile test refers to a tensile stress at an elongation of 40% determined after extension of 50% at 70° C., releasing the stress, and then measuring the tensile stress at an elongation of 40% at 70° C. in accordance with JIS K 6251:2010; and
   40% modulus at 70° C. before a tensile test refers to a tensile stress at an elongation of 40% measured before the tensile test at 70° C. in accordance with JIS K 6251:2010.

### TECHNICAL FIELD

The present disclosure relates to a rubber composition and a tire including the rubber composition.

### BACKGROUND ART

Addition of silica, for example, is proposed as a technique to improve the wet performance of tires. However, an improvement in wet performance (performance on a wet road surface) tends to reduce dry performance (performance on a dry road surface). There has been a desire to achieve both these performances.

### SUMMARY OF DISCLOSURE

### Technical Problem

The present disclosure aims to solve the above problem and provide a rubber composition and a tire which can suppress changes in performances caused by changes in road conditions from dry to wet road surface or from wet to dry road surface.

### Solution to Problem

Although the wet grip performance of tires has greatly advanced due to technical improvement of silica-containing tread rubber, there is still a remaining issue of changes in performances caused by, for example, changes in road conditions from dry to wet road surface or from wet to dry road surface, as a technical problem.

Specifically, a conventional rubber composition on a wet road surface is cooled by water on the road surface and becomes hard, so that the contact area with the road surface decreases. Consequently, the wet grip performance tends to be reduced as compared to the dry grip performance. Wet grip performance can be improved by adding a softening agent to soften rubber. This technique is disadvantageous in that the softened rubber impairs dry performance.

In order to overcome the disadvantage, the Applicant of the present application proposed a tread rubber that contains ionic bonds formed between, for example, methacrylic acid and a metal compound and thus changes its physical properties in response to water advantageous for wet performance, such as reduction of modulus of elasticity and increase of tan δ, thereby achieving both the dry performance and the wet performance at a high level.

However, the Applicant found that the above-described technique is still not sufficient in achieving both the performances and found a new problem that, particularly when driving alternately on a dry road surface and a wet road surface is repeated, the grip performance in driving on a dry road surface is reduced by the driving history.

The Applicant found a solution to the new problem; specifically, a rubber composition satisfying not only the formulas (1) and (2) but also the formula (3), which are described later, can suppress changes in performances caused by changes in road conditions from dry to wet road surface or from wet to dry road surface. Based on this knowledge, the present disclosure was completed.

The present disclosure relates to a rubber composition having E* when wet with water (MPa), E* when dry (MPa), tan δ when wet with water, tan δ when dry, 40% modulus (MPa) at 70° C. before a tensile test, and 40% modulus (MPa) at 70° C. after the tensile test which satisfy the following formulas (1) to (3):
(1) E* when wet with water/E* when dry≤0.90
(2) tan δ when wet with water/tan δ when dry >1.00
(3) 40% modulus at 70° C. after tensile test/40% modulus at 70° C. before tensile test Z 0.45
where
   E* and tan δ refer to a complex modulus of elasticity and a loss tangent, respectively, after 30 minutes from the start of measurement under the conditions of a temperature of 30° C., an initial strain of 10%, a dynamic strain of 1%, a frequency of 10 Hz, an elongation mode, and a measurement duration of 30 minutes;
   40% modulus at 70° C. after the tensile test refers to a tensile stress at an elongation of 40% determined after extension of 50% at 70° C., releasing the stress, and then measuring the tensile stress at an elongation of 40% at 70° C. in accordance with JIS K 6251:2010; and
   40% modulus at 70° C. before a tensile test refers to a tensile stress at an elongation of 40% measured before the tensile test at 70° C. in accordance with JIS K 6251:2010.

### Advantageous Effects of Disclosure

The rubber composition of the present disclosure satisfies the formulas (1) to (3). This rubber composition can suppress changes in performances caused by changes in road conditions from dry to wet road surface or from wet to dry road surface.

### BRIEF DESCRIPTION OF DRAWINGS

FIG. 1 shows a cross-sectional view of a part of a pneumatic tire according to an embodiment of the present disclosure taken in the meridional direction of the tire.

FIG. 2 shows a cross-sectional view of a tread portion of a tire taken along a plane including the tire axis.

### DESCRIPTION OF EMBODIMENTS

### <Rubber Composition>

The present disclosure relates to a rubber composition satisfying the formulas (1) to (3). This rubber composition can suppress changes in performances caused by changes in road conditions from dry to wet road surface or from wet to dry road surface. Thus, the rubber composition can maintain good wet performance and good dry performance even if changes in road conditions occur during driving.

The mechanism for the advantageous effect is not completely clear, but it is assumed as follows.

In order to suppress a reduction in the grip performance caused by the change from dry to wet road surface, selective reduction of the modulus of elasticity and increased tan δ with water are considered necessary.

For this purpose, it is considered important to satisfy the formula (1): E* when wet with water/E* when dry ≤0.90 and the formula (2): tan δ when wet with water/tan δ when dry >1.00. Use of at least one diene-based rubber in which cross-linking is partly or fully cross-linked by ionic bonds is considered effective to satisfy the formulas. When the cross-linking in a polymer component involves ionic bonds, due to the reversibility of the ionic bonds which are non-covalent bonds, the modulus of elasticity can be reduced only when wet with water, and also tan δ can be increased by the relaxation. Since ionic bonds are the strongest among non-covalent bonds, the binding force can be maintained when dry.

Meanwhile, the rubber composition which can be softened with water as described above and can also increase heat generation has a nature that the bonds such as ionic bonds in the rubber can be reversibly dissociated with water. The rubber composition with such a nature tends to be entirely softened by the heat and deformation during driving on the road. When the road conditions change from wet to dry road surface, the rubber composition is affected by the change history and is softened. The softened rubber composition tends to have a difficulty in obtaining sufficient grip performance in driving on a dry road surface.

Therefore, the modulus of the rubber with the history of deformation is increased by further satisfying the formula (3): 40% modulus at 70° C. after tensile test/40% modulus at 70° C. before tensile test ≥0.45 to reduce changes in performances caused by the history during driving. The rubber composition may thus obtain good grip performance even when the road conditions repeatedly change from wet to dry road surface.

Presumably, the above-described mechanism suppresses changes in performances caused by changes in road conditions from dry to wet road surface or from wet to dry road surface.

As described above, the rubber composition solves the problem (aim) in suppressing changes in performances caused by changes in road conditions from dry to wet road surface or from wet to dry road surface, due to its structure in which the E* when wet with water (MPa), the E* when dry (MPa), the tan δ when wet with water, the tan δ when dry, the 40% modulus (MPa) at 70° C. before a tensile test, and the 40% modulus (MPa) at 70° C. after the tensile test satisfy the formula (1): E* when wet with water/E* when dry ≤0.90, the formula (2): tan δ when wet with water/tan δ when dry >1.00, and the formula (3): 40% modulus at 70° C. after tensile test/40% modulus at 70° C. before tensile test ≥0.45. In other words, the parameters of the formula (1): E* when wet with water/E* when dry ≤0.90, the formula (2): tan δ when wet with water/tan δ when dry >1.00, and the formula (3): 40% modulus at 70° C. after tensile test/40% modulus at 70° C. before tensile test ≥0.45 do not define the problem (aim). The problem herein is to suppress changes in performances caused by changes in road conditions from dry to wet road surface or from wet to dry road surface. In order to solve the problem, the rubber composition has been formulated to satisfy the parameters.

Herein, the complex modulus of elasticity (E*), the loss tangent (tan δ), the 40% modulus (MPa) at 70° C. before a tensile test, and the 40% modulus (MPa) at 70° C. after the tensile test of the rubber composition mean the E*, the tan δ, and the 40% moduli of the vulcanized rubber composition.

The E* and the tan δ are measured by viscoelastic testing of the vulcanized rubber composition. The 40% modulus refers to a modulus at a strain of 40% of the vulcanized rubber composition measured in accordance with JIS K 6251:2010.

The rubber composition satisfies the formula (1) and the formula (2) and reversibly changes the complex modulus of elasticity (E*) and the loss tangent (tan δ) with water, for example. Herein, the expression “reversibly changes the complex modulus of elasticity (E*) and the loss tangent (tan δ) with water” means that the E* and the tan δ of the (vulcanized) rubber composition reversibly increase or decrease depending on the presence of water. It is sufficient that the E* and tan δ reversibly change when the state of the rubber composition changes as follows: dry wet with water→dry, for example. The rubber composition in the former dry state may not have the same E* or tan δ as that in the latter dry state or may have the same E* or tan δ as that in the latter dry state.

Herein, the term “E* and tan δ when dry” means the E* and tan δ, respectively, of the rubber composition which is dry and specifically refers to the E* and the tan δ of the rubber composition which has been dried by the method described in EXAMPLES.

Herein, the term “E* and tan δ when wet with water” means the E* and tan δ, respectively, of the rubber composition which is wet with water and specifically refers to the E* and the tan δ of the rubber composition which has been wet with water by the method described in EXAMPLES.

Herein, the E* and the tan δ of the rubber composition are the E* and tan δ after 30 minutes from the start of the measurement under the conditions of a temperature of 30° C., an initial strain of 10%, a dynamic strain of 1%, a frequency of 10 Hz, an elongation mode, and a measurement duration of 30 minutes.

Herein, the 40% modulus at 70° C. after the tensile test refers to a modulus (tensile stress) at an elongation of 40% determined after subjecting a rubber composition (test piece) to 50% elongation of the rubber composition at 70° C., releasing (removing) the stress, and then measuring the tensile stress of the stress-released rubber composition at an elongation of 40% at 70° C. in accordance with JIS K 6251:2010. The 40% modulus at 70° C. before a tensile test refers to a modulus (tensile stress) at an elongation of 40% measured in accordance with JIS K 6251:2010 before subjecting the rubber composition (test piece) to the tensile test at 70° C. Specifically, the 40% moduli refer to moduli (tensile stresses) at an elongation of 40% before and after a tensile test at 70° C. determined by the method described in EXAMPLES.

Herein, the 40% modulus of the rubber composition refers to a stress (MPa) at an elongation of 40% measured by a tensile test at 200 mm/min using a #7 dumbbell test piece in accordance with “Rubber, vulcanized or thermoplastic-Determination of tensile stress-strain properties” specified in JIS K 6251:2010. The 40% modulus at 70° C. after the tensile test is a value measured at a temperature of 70° C., and the 40% modulus at 70° C. before a tensile test is a value measured at a temperature of 70° C.

The rubber composition satisfies the following formula (1):
(1) E* when wet with water/E* when dry ≤0.90 where E* refers to a complex modulus of elasticity (MPa) after 30 minutes from the start of measurement under the conditions of a temperature of 30° C., an initial strain of 10%, a dynamic strain of 1%, a frequency of 10 Hz, an elongation mode, and a measurement duration of 30 minutes.

The value of “E* when wet with water/E* when dry” is preferably 0.89 or less, more preferably 0.88 or less, still more preferably 0.87 or less, further preferably 0.86 or less, still more preferably 0.85 or less, particularly preferably 0.84 or less. The lower limit of the value of “E* when wet with water/E* when dry” is not limited, and it is preferably 0.10 or more, more preferably 0.30 or more, still more preferably 0.50 or more, particularly preferably 0.60 or more. When the value is within the range indicated above, the advantageous effect can be suitably achieved.

The E* when dry of the rubber composition is preferably 2.5 MPa or more, more preferably 5.0 MPa or more, still more preferably 7.0 MPa or more, further preferably 8.0 MPa or more, further preferably 8.12 MPa or more, further preferably 8.23 MPa or more, further preferably 8.3 MPa or more, further preferably 8.6 MPa or more, further preferably 8.1 MPa or more, further preferably 8.76 MPa or more, further preferably 8.87 MPa or more, further preferably 8.9 or more, further preferably 8.99 MPa or more, further preferably 9.0 MPa or more, further preferably 9.03 MPa or more, further preferably 9.1 MPa or more, further preferably 9.26 MPa or more, further preferably 9.4 MPa or more, further preferably 9.44 MPa or more, further preferably 9.54 MPa or more, further preferably 9.6 MPa or more, further preferably 9.7 MPa or more, further preferably 9.76 MPa or more, further preferably 9.9 MPa or more. The upper limit of E* when dry is not limited, and it is preferably 20.0 MPa or less, more preferably 15.0 MPa or less, still more preferably 13.0 MPa or less, particularly preferably 12.0 MPa or less. When the E* is within the range indicated above, the advantageous effect can be suitably achieved.

The E* when wet with water of the rubber composition is preferably 2.2 MPa or more, more preferably 4.5 MPa or more, still more preferably 6.0 MPa or more, further preferably 7.0 MPa or more, further preferably 7.06 MPa or more, further preferably 7.08 MPa or more, further preferably 7.1 MPa or more, further preferably 7.4 MPa or more, further preferably 7.6 MPa or more, further preferably 7.66 MPa or more, further preferably 7.71 MPa or more, further preferably 7.82 MPa or more, further preferably 7.89 MPa or more, further preferably 7.9 MPa or more, further preferably 7.92 MPa or more, further preferably 8.0 MPa or more, further preferably 8.06 MPa or more, further preferably 8.1 MPa or more, further preferably 8.13 MPa or more, further preferably 8.3 MPa or more, further preferably 8.4 MPa or more, further preferably 8.49 MPa or more, further preferably 8.59 MPa or more, further preferably 8.6 MPa or more. The upper limit of E* when dry is not limited, and it is preferably 18.0 MPa or less, more preferably 13.0 MPa or less, still more preferably 11.0 MPa or less, particularly preferably 10.0 MPa or less. When the E* is within the range indicated above, the advantageous effect can be suitably achieved.

The rubber composition satisfies the following formula (2):
(2) tan δ when wet with water/tan δ when dry >1.00 where tan δ refers to a loss tangent after 30 minutes from the start of measurement under the conditions of a temperature of 30° C., an initial strain of 10%, a dynamic strain of 1%, a frequency of 10 Hz, an elongation mode, and a measurement duration of 30 minutes.

The value of “tan δ when wet with water/tan δ when dry” is preferably 1.11 or more, more preferably 1.12 or more, still more preferably 1.13 or more, further preferably 1.14 or more, further preferably 1.15 or more, particularly preferably 1.16 or more. The upper limit of the value of “tan δ when wet with water/tan δ when dry” is not limited, and it is preferably 1.80 or less, more preferably 1.70 or less, still more preferably 1.65 or less, particularly preferably 1.60 or less. When the value is within the range indicated above, the advantageous effect can be suitably achieved.

The tan δ when dry of the rubber composition is preferably 0.15 or more, more preferably 0.19 or more, still more preferably 0.21 or more, further preferably 0.22 or more, further preferably 0.23 or more, further preferably 0.24 or more, further preferably 0.25 or more, further preferably 0.26 or more, further preferably 0.27 or more, further preferably 0.28 or more, further preferably 0.29 or more, further preferably 0.32 or more. The upper limit of the tan δ when dry is not limited, and it is preferably 0.40 or less, more preferably 0.38 or less, still more preferably 0.36 or less, particularly preferably 0.34 or less. When the tan δ is within the range indicated above, the advantageous effect can be suitably achieved.

The tan δ when wet with water of the rubber composition is preferably 0.16 or more, more preferably 0.21 or more, still more preferably 0.22 or more, further preferably 0.23 or more, further preferably 0.25 or more, further preferably 0.26 or more, further preferably 0.27 or more, further preferably 0.28 or more, further preferably 0.29 or more, further preferably 0.30 or more, further preferably 0.31 or more, further preferably 0.32 or more, further preferably 0.33 or more. The upper limit of the tan δ when wet with water is not limited, and it is preferably 0.41 or less, more preferably 0.39 or less, still more preferably 0.37 or less, further preferably 0.36 or less, particularly preferably 0.35 or less. When the tan δ is within the range indicated above, the advantageous effect can be suitably achieved.

The reversible change with water in E* and in tan δ represented by the formula (1) and the formula (2) in the rubber composition can be achieved by introducing ionic bonds which change with water and the like into the rubber composition by, for example, adding a modified rubber containing at least one selected from the group consisting of carboxylic acid, sulfonic acid, and salts thereof in its molecule, which is described later, and at least one alkali metal salt or alkaline earth metal salt selected from the group consisting of lithium carbonate, sodium carbonate, potassium carbonate, rubidium carbonate, cesium carbonate, beryllium carbonate, magnesium carbonate, calcium carbonate, strontium carbonate, barium carbonate, lithium acetate, sodium acetate, potassium acetate, rubidium acetate, cesium acetate, beryllium acetate, magnesium acetate, calcium acetate, strontium acetate, barium acetate, lithium phenoxide, sodium phenoxide, potassium phenoxide, rubidium phenoxide, cesium phenoxide, beryllium diphenoxide, magnesium diphenoxide, calcium diphenoxide, strontium diphenoxide, and barium diphenoxide, which is described later.

Specifically, the reversible change with water in E* and in tan δ represented by the formula (1) and the formula (2) of the rubber composition can be achieved by introduction of ionic bonds which reversibly change with water and the like into the rubber composition using a combination of a modified rubber containing at least one selected from the group consisting of carboxylic acid, sulfonic acid, and salts thereof in its molecule such as a carboxylic acid-modified SBR with an alkali metal salt or alkaline earth metal salt such as lithium acetate. Owing to the combination, for example, the anion derived from the carboxylic acid, sulfonic acid, or salts thereof and the cation derived from the alkali metal salt or alkaline earth metal salt can form ionic bonds between the modified rubber and the alkali metal salt or alkaline earth metal salt.

Then, the ionic bonds may be cleaved by adding water and re-formed by drying water. Consequently, the E* decreases and/or the tan δ increases when wet with water, while the E* increases and/or the tan δ decreases when dry. Presumably, the reversible change can be thus achieved.

The E* when dry can be controlled by the types and the amounts of chemicals (in particular, rubber components, fillers, or softening agents such as oils) blended in the rubber composition. For example, the E* when dry tends to be increased by reducing the amount of softening agents or increasing the amount of fillers.

The tan δ when dry can be controlled by the types and the amounts of chemicals (in particular, rubber components, fillers, softening agents, resins, sulfur, vulcanization accelerators, or silane coupling agents) blended in the rubber composition. For example, the tan δ when dry tends to be increased by using softening agents (e.g., resin) with low compatibility with rubber components, using unmodified rubbers, increasing the amount of fillers, increasing oils as plasticizers, reducing sulfur, reducing vulcanization accelerators, or increasing silane coupling agents.

The E* and tan δ when dry can be controlled by, for example, varying the acid functional group content of the modified rubber or the amount of the alkali metal salt or alkaline earth metal salt (specifically, the amount of metal derived from the alkali metal salt or alkaline earth metal salt). Specifically, when the acid functional group content of the modified rubber or the amount of the alkali metal salt or alkaline earth metal salt is increased, the E* when dry tends to increase and the tan δ when dry tends to increase.

The E* when wet with water can be reduced and/or the tan δ when wet with water can be increased, as compared to the value when dry, in the rubber composition in which the cross-links between the modified rubber and the alkali metal salt or alkaline earth metal salt are partly or fully formed by ionic bonds, for example. Thus, the E* and the tan δ when wet with water and when dry can be controlled. Specifically, the use of a combination of the modified rubber with the alkali metal salt or alkaline earth metal salt provides a rubber composition in which the rubber and the salt are cross-linked by ionic bonds, and thus the E* when wet with water can be reduced and/or the tan δ when wet with water can be increased as compared to the value when dry. The E* and the tan δ when wet with water can be controlled by varying the amounts or the types of the chemicals in the rubber composition. For example, the above-described techniques to control the E* when dry and the tan δ when dry can cause the above-described tendencies also in the E* and tan δ when wet with water.

Further, specifically, the reversible changes with water in E* and in tan δ represented by the formula (1) and the formula (2) in the rubber composition can be achieved by controlling the E* and the tan δ when dry to fall within the predetermined ranges and then using a combination of the modified rubber containing at least one selected from the group consisting of carboxylic acid, sulfonic acid, and salts thereof in its molecule with the alkali metal salt or alkaline earth metal salt.

The rubber composition satisfies the following formula (3):
(3) 40% modulus at 70° C. after tensile test/40% modulus at 70° C. before tensile test ≥0.45
where 40% modulus at 70° C. after the tensile test refers to a tensile stress at an elongation of 40% determined after extension of 50% at 70° C., releasing the stress, and then measuring the tensile stress at an elongation of 40% at 70° C. in accordance with JIS K 6251:2010, and 40% modulus at 70° C. before a tensile test refers to a tensile stress at an elongation of 40% measured before the tensile test at 70° C. in accordance with JIS K 6251:2010.

The value of “40% modulus at 70° C. after tensile test/40% modulus at 70° C. before tensile test” is preferably 0.50 or more, more preferably 0.52 or more, still more preferably 0.53 or more, further preferably 0.54 or more, further preferably 0.55 or more, further preferably 0.56 or more, further preferably 0.57 or more, further preferably 0.58 or more, further preferably 0.60 or more, further preferably 0.61 or more, further preferably 0.62 or more, further preferably 0.64 or more. The upper limit of the value of “40% modulus at 70° C. after tensile test/40% modulus at 70° C. before tensile test” is not limited, and it is preferably 0.85 or less, more preferably 0.80 or less, still more preferably 0.75 or less, particularly preferably 0.70 or less. When the value is within the range indicated above, the advantageous effect can be suitably achieved.

The 40% modulus at 70° C. before a tensile test of the rubber composition is preferably 0.70 MPa or more, more preferably 0.80 MPa or more, still more preferably 0.86 MPa or more, further preferably 0.87 MPa or more, further preferably 0.89 MPa or more, further preferably 0.90 MPa or more, further preferably 0.91 MPa or more, further preferably 0.93 MPa or more, further preferably 0.94 MPa or more, further preferably 0.95 MPa or more, further preferably 0.96 MPa or more, further preferably 0.97 MPa or more, further preferably 0.98 MPa or more, further preferably 0.99 MPa or more, further preferably 1.00 MPa or more, further preferably 1.02 MPa or more, further preferably 1.03 MPa or more, further preferably 1.05 MPa or more, further preferably 1.07 MPa or more. The upper limit is preferably 2.00 MPa or less, more preferably 1.80 MPa or less, still more preferably 1.60 MPa or less. When the 40% modulus is within the range indicated above, the advantageous effect can be suitably achieved.

The 40% modulus at 70° C. after the tensile test of the rubber composition is preferably 0.40 MPa or more, more preferably 0.43 MPa or more, still more preferably 0.45 MPa or more, further preferably 0.46 MPa or more, further preferably 0.47 MPa or more, further preferably 0.49 MPa or more, further preferably 0.50 MPa or more, further preferably 0.51 MPa or more, further preferably 0.53 MPa or more, further preferably 0.54 MPa or more, further preferably 0.55 MPa or more, further preferably 0.56 MPa or more, further preferably 0.57 MPa or more, further preferably 0.58 MPa or more, further preferably 0.60 MPa or more, further preferably 0.62 MPa or more, further preferably 0.63 MPa or more, further preferably 0.65 MPa or more, particularly preferably 0.70 MPa or more. The upper limit is preferably 1.40 MPa or less, more preferably 1.20 MPa or less, still more preferably 1.00 MPa or less. When the 40% modulus is within the range indicated above, the advantageous effect can be suitably achieved.

The relationship expressed by the formula (3) in the rubber composition can be achieved by forming a network in the rubber, for example, using a technique such as increasing the amount of sulfur, increasing coupling agents (e.g., silane coupling agents), using mercapto silane coupling agents, or increasing the proportion of carbon black among filler components.

The 40% modulus at 70° C. before a tensile test can be controlled by the types and amounts of chemicals (in particular, rubber components, fillers, softening agents such as oils, coupling agents, etc.) in the rubber composition. For example, the 40% modulus at 70° C. before a tensile test tends to be increased by increasing the amount of sulfur, increasing the amount of coupling agents, using mercapto silane coupling agents, increasing the amount of fillers, or reducing the amount of plasticizers.

The 40% modulus at 70° C. after the tensile test can be controlled by the types and amounts of chemicals in the rubber composition. For example, the above-described techniques to control the 40% modulus at 70° C. before a tensile test can cause the above-described tendencies also in the 40% modulus at 70° C. after the tensile test.

When the rubber composition is used in a tread of a tire, the rubber composition (sample) used for measuring the E* when wet with water (MPa), the E* when dry (MPa), tan δ when wet with water, the tan δ when dry, the 40% modulus (MPa) at 70° C. before a tensile test, and the 40% modulus (MPa) at 70° C. after the tensile test is collected from the tread portion of the tire.

### (Rubber Component)

The rubber composition preferably contains, as a rubber component, a modified rubber containing at least one selected from the group consisting of carboxylic acid (carboxylic acid group (—COOH)), sulfonic acid (sulfuric acid group (—SO₃H)), and salts thereof (salts consisting of at least one of carboxylic acid ion (—COO—) or sulfonic acid ion (—SO₃—) and a counter cation of the ion) in its molecule. Non-limiting examples of the salts include monovalent metal salts such as alkali metal salts (sodium salt, potassium salt, etc.) and divalent metal salts such as alkaline earth metal salts (calcium salt, strontium salt, etc.). In order to better achieve the advantageous effect, a carboxylic acid group is preferred, a (meth)acrylic acid group and a maleic acid group are more preferred, and a methacrylic acid group and a maleic acid group are particularly preferred among these. Specific suitable examples include an emulsion-polymerized styrene-butadiene rubber having methacrylic acid in its molecule.

The modified rubber contains an ionic functional group that is at least one selected from the group consisting of carboxylic acid, sulfonic acid, and salts thereof in its molecule. The amount of the ionic functional group based on 100% by mass of the rubber (based on 100% by mass of the rubber containing the ionic functional group in its molecule) is preferably 0.5% by mass or more, more preferably 0.8% by mass or more, still more preferably 1.0% by mass or more, further preferably 5.0% by mass or more. The upper limit is not limited, and it is preferably 40% by mass or less, more preferably 35% by mass or less.

The amount of the ionic functional group can be measured by performing NMR analysis and then calculating the amount (% by mass) from the peak corresponding to the ionic functional group.

The amount of the modified rubber based on 100% by mass of the rubber component in the rubber composition is preferably 5% by mass or more, more preferably 20% by mass or more, still more preferably 40% by mass or more, particularly preferably 50% by mass or more. The upper limit is not limited, and it is preferably 90% by mass or less, more preferably 85% by mass or less, still more preferably 80% by mass or less, particularly preferably 75% by mass or less. When the amount is within the range indicated above, the advantageous effect can be suitably achieved.

In order to suitably achieve the advantageous effect, the rubber constituting the backbone of the modified rubber preferably contains at least one monomer selected from the group consisting of styrene, butadiene, and isoprene as a structural unit. Specific examples of the rubber include isoprene-based rubbers, polybutadiene rubber (BR), styrene-butadiene rubber (SBR), and styrene-isoprene-butadiene rubber (SIBR). The rubber component constituting the backbones of these modified rubbers may each be a single rubber component or a combination of two or more thereof.

In order to better achieve the advantageous effect, the rubber component preferably includes one of SBR, BR, and isoprene-based rubbers, more preferably includes one of SBR and BR. The modified SBR and the modified BR may be used in combination.

Non-limiting examples of the SBR include emulsion-polymerized styrene-butadiene rubber (E-SBR) and solution-polymerized styrene-butadiene rubber (S-SBR). These may be used alone or in combinations of two or more.

The styrene content of the SBR is preferably 5% by mass or higher, more preferably 10% by mass or higher, still more preferably 15% by mass or higher, further preferably 23% by mass or higher. The styrene content is preferably 60% by mass or lower, more preferably 40% by mass or lower, still more preferably 30% by mass or lower.

When the styrene content is within the range indicated above, the advantageous effect tends to be better achieved.

Herein, the styrene content of SBR is calculated by ¹H-NMR analysis.

The vinyl content of the SBR is preferably 5% by mass or higher, more preferably 10% by mass or higher, still more preferably 15% by mass or higher. The vinyl content is preferably 75% by mass or lower, more preferably 70% by mass or lower. When the vinyl content is within the range indicated above, the advantageous effect tends to be better achieved.

The vinyl content (1,2-bonded butadiene unit content) can be measured by infrared absorption spectrometry.

SBR products manufactured or sold by Sumitomo Chemical Co., Ltd., JSR Corporation, Asahi Kasei Corporation, Zeon Corporation, etc., may be used as the SBR.

When the rubber composition contains, as the modified rubber, a modified SBR containing the ionic functional group that is at least one selected from the group consisting of carboxylic acid, sulfonic acid, and salts thereof in its molecule, the amount of the modified SBR based on 100% by mass of the rubber component is preferably 5% by mass or more, more preferably 20% by mass or more, still more preferably 40% by mass or more, particularly preferably 50% by mass or more. The upper limit is not limited, and it is preferably 90% by mass or less, more preferably 85% by mass or less, still more preferably 80% by mass or less, particularly preferably 75% by mass or less. When the amount is within the range indicated above, the advantageous effect can be suitably achieved.

Any BR may be used, such as high-cis BR having a high cis content, BR containing syndiotactic polybutadiene crystals, or BR synthesized using rare earth catalysts (rare earth-catalyzed BR). These may be used alone or in combination of two or more. High-cis BR having a cis content of 90% by mass or higher is preferred to improve abrasion resistance. Here, the cis content can be measured by infrared absorption spectrometry.

When the rubber composition contains, as the modified rubber, a modified BR containing the ionic functional group that is at least one selected from the group consisting of carboxylic acid, sulfonic acid, and salts thereof in its molecule, the amount of the modified BR based on 100% by mass of the rubber component is preferably 5% by mass or more, more preferably 20% by mass or more, still more preferably 40% by mass or more, particularly preferably 50% by mass or more. The upper limit is not limited, and it is preferably 90% by mass or less, more preferably 85% by mass or less, still more preferably 80% by mass or less, particularly preferably 75% by mass or less. When the amount is within the range indicated above, the advantageous effect can be suitably achieved.

Examples of isoprene-based rubbers include natural rubber (NR), polyisoprene rubber (IR), refined NR, modified NR, and modified IR. Examples of NR include those commonly used in the rubber industry such as SIR20, RSS #3, and TSR20. Any IR may be used, including those commonly used in the rubber industry such as IR2200. Examples of refined NR include deproteinized natural rubbers (DPNR) and highly purified natural rubbers (UPNR). Examples of modified NR include epoxidized natural rubbers (ENR), hydrogenated natural rubbers (HNR), and grafted natural rubbers. Examples of modified IR include epoxidized polyisoprene rubbers, hydrogenated polyisoprene rubbers, and grafted polyisoprene rubbers. These may be used alone or in combinations of two or more.

When the rubber composition contains, as the modified rubber, a modified isoprene-based rubber containing the ionic functional group that is at least one selected from the group consisting of carboxylic acid, sulfonic acid, and salts thereof in its molecule, the amount of the modified isoprene-based rubber based on 100% by mass of the rubber component is preferably 5% by mass or more, more preferably 10% by mass or more, still more preferably 15% by mass or more, particularly preferably 20% by mass or more. The upper limit is not limited, and it is preferably 80% by mass or less, more preferably 50% by mass or less, still more preferably 40% by mass or less, particularly preferably 35% by mass or less. When the amount is within the range indicated above, the advantageous effect can be suitably achieved.

The rubber composition may contain a different rubber component other than the modified rubber. The different rubber usable in the rubber composition is preferably at least one selected from the group consisting of SBR, BR, and isoprene-based rubbers. The SBR, the BR, and the isoprene-based rubbers each may be a modified rubber other than the modified rubber or an unmodified rubber. Unmodified SBR, unmodified BR, and unmodified isoprene-based rubbers are preferred, and unmodified SBR and unmodified BR are more preferred.

When the rubber composition contains a different rubber component other than the modified rubber, the amount of the different rubber component based on 100% by mass of the rubber component is preferably 5% by mass or more, more preferably 10% by mass or more, still more preferably 15% by mass or more, particularly preferably 20% by mass or more. The upper limit is not limited, and it is preferably 80% by mass or less, more preferably 50% by mass or less, still more preferably 40% by mass or less, particularly preferably 35% by mass or less. When the amount is within the range indicated above, the advantageous effect can be suitably achieved. When unmodified isoprene-based rubber or unmodified BR is used as the different rubber, the amount of the unmodified isoprene-based rubbers or the amount of the unmodified BR is suitably within the range indicated above.

Examples of the different rubber component include rubbers (isoprene-based rubbers, BR, SBR, SIBR, etc.) usable as the backbone of the above-described modified rubber. The different rubber component may be either an unmodified rubber or a modified rubber other than the above-described modified rubber. These may be used alone or in combinations of two or more.

Examples of modified rubbers (modified rubbers other than the above-described modified rubber) as the different rubber components include those in which below-described functional groups interactive with fillers such as silica have been introduced by modification.

Examples of the functional group include a silicon-containing group (—SiR₃ where each R is the same or different and represents a hydrogen atom, a hydroxyl group, a hydrocarbon group, an alkoxy group, or the like), an amino group, an amide group, an isocyanate group, an imino group, an imidazole group, a urea group, an ether group, a carbonyl group, an oxycarbonyl group, a mercapto group, a sulfide group, a disulfide group, a sulfonyl group, a sulfinyl group, a thiocarbonyl group, an ammonium group, an imide group, a hydrazo group, an azo group, a diazo group, a carboxy group, a nitrile group, a pyridyl group, an alkoxy group, a hydroxyl group, an oxy group, and an epoxy group, each of which may be substituted. Preferred among these is a silicon-containing group. More preferred is —SiR₃ where each R is the same or different and represents a hydrogen atom, a hydroxyl group, a hydrocarbon group (preferably a C1-C6 hydrocarbon group, more preferably a C1-C6 alkyl group), or an alkoxy group (preferably a C1-C6 alkoxy group), and at least one R is a hydroxy group.

Specific examples of the compound (modifier) used to introduce the functional group include 2-dimethylaminoethyltrimethoxysilane, 3-dimethylaminopropyltrimethoxysilane, 2-dimethylaminoethyltriethoxysilane, 3-dimethylaminopropyltriethoxysilane, 2-diethylaminoethyltrimethoxysilane, 3-diethylaminopropyltrimethoxysilane, 2-diethylaminoethyltriethoxysilane, and 3-diethylaminopropyltriethoxysilane.

The amount of SBR (total amount of the above-described modified SBR, modified SBR other than the above-described modified SBR, and unmodified SBR), if present, in the rubber composition based on 100% by mass of the rubber component is preferably 5% by mass or more, more preferably 20% by mass or more, still more preferably 30% by mass or more, further preferably 50% by mass or more, particularly preferably 70% by mass or more. The upper limit is not limited, and it is preferably 90% by mass or less, more preferably 85% by mass or less, still more preferably 80% by mass or less. When the amount is within the range indicated above, the advantageous effect can be suitably achieved.

The amount of BR (total amount of the above-described modified BR, modified BR other than the above-described modified BR, and unmodified BR), if present, in the rubber composition based on 100% by mass of the rubber component is preferably 5% by mass or more, more preferably 20% by mass or more, still more preferably 30% by mass or more, further preferably 50% by mass or more, particularly preferably 70% by mass or more. The upper limit is not limited, and it is preferably 90% by mass or less, more preferably 85% by mass or less, still more preferably 80% by mass or less. When the amount is within the range indicated above, the advantageous effect can be suitably achieved.

The amount of isoprene-based rubbers (total amount of the above-described modified isoprene-based rubbers, modified isoprene-based rubbers other than the above-described modified isoprene-based rubbers, and unmodified isoprene-based rubbers), if present, in the rubber composition based on 100% by mass of the rubber component is preferably 5% by mass or more, more preferably 8% by mass or more, still more preferably 10% by mass or more. The upper limit is not limited, and it is preferably 50% by mass or less, more preferably 30% by mass or less, still more preferably 20% by mass or less. When the amount is within the range indicated above, the advantageous effect can be suitably achieved.

The total amount of SBR and BR (total amount of the above-described modified SBR, modified SBR other than the above-described modified SBR, unmodified SBR, the above-described modified BR, modified BR other than the above-described modified BR, and unmodified BR), if present, in the rubber composition based on 100% by mass of the rubber component is preferably 50% by mass or more, more preferably 75% by mass or more, still more preferably 85% by mass or more, particularly preferably 90% by mass or more. When the amount is within the range indicated above, the advantageous effect tends to be better achieved.

### (Alkali Metal Salt or Alkaline Earth Metal Salt)

The rubber composition preferably contains at least one alkali metal salt or alkaline earth metal salt selected from the group consisting of lithium carbonate, sodium carbonate, potassium carbonate, rubidium carbonate, cesium carbonate, beryllium carbonate, magnesium carbonate, calcium carbonate, strontium carbonate, barium carbonate, lithium acetate, sodium acetate, potassium acetate, rubidium acetate, cesium acetate, beryllium acetate, magnesium acetate, calcium acetate, strontium acetate, barium acetate, lithium phenoxide, sodium phenoxide, potassium phenoxide, rubidium phenoxide, cesium phenoxide, beryllium diphenoxide, magnesium diphenoxide, calcium diphenoxide, strontium diphenoxide, and barium diphenoxide. The alkali metal salt or alkaline earth metal salt may be used alone or in combinations of two or more.

In order to more suitably achieve the advantageous effect, the rubber composition more preferably contains at least one selected from the group consisting of potassium acetate, calcium acetate, sodium acetate, and magnesium acetate, still more preferably contains at least one selected from the group consisting of potassium acetate, calcium acetate, and sodium acetate, and particularly preferably contains at least one of potassium acetate or calcium acetate.

The reason why the above-described advantageous effect can be better achieved when the alkali metal salts or alkaline earth metal salts are used is not completely clear, but it is probably due to the following mechanism.

In the combination of the modified rubber containing a carboxylic acid or the like in its molecule with the specific alkali metal salt or alkaline earth metal salt, ionic bonds are formed between the carboxylic acid or the like and the metal of the alkali metal salt or alkaline earth metal salt. The ionic bonds are cleaved with water and reversibly formed when dry, so that reversible change in E* and reversible change in tan δ with water occur. In particular, the specific alkali metal salt or alkaline earth metal salt is considered to provide high reinforcement and be highly responsive to the reversible change. Moreover, the specific alkali metal salt or alkaline earth metal salt is easily dissociated with water and therefore may further increase the reversible change in E* and the reversible change in tan δ with water. Thus, presumably, the rubber composition containing the specific alkali metal salt or alkaline earth metal salt can achieve both better wet grip performance and better dry grip performance.

The amount of the alkali metal salt or alkaline earth metal salt (total amount of the alkali metal salt and alkaline earth metal salt) per 100 parts by mass of the rubber component in the rubber composition is preferably 0.5 parts by mass or more, more preferably 1.0 parts by mass or more, still more preferably 2.0 parts by mass or more, further preferably 2.2 parts by mass or more, further preferably 5.0 parts by mass or more, further preferably 7.24 parts by mass or more, while it is preferably 20.0 parts by mass or less, more preferably 17.0 parts by mass or less, still more preferably 12.0 parts by mass or less, further preferably 11.66 parts by mass or less, particularly preferably 10.0 parts by mass or less. When the amount is within the range indicated above, the advantageous effect tends to be better achieved.

The apparent specific gravity of the alkali metal salt or alkaline earth metal salt is preferably less than 0.4 g/ml, more preferably 0.3 g/ml or less, still more preferably 0.25 g/ml or less, while it is preferably 0.05 g/ml or more, more preferably 0.15 g/ml or more. When the apparent specific gravity is within the range indicated above, the advantageous effect tends to be better achieved.

Here, the apparent specific gravity of the alkali metal salt or alkaline earth metal salt is determined by weighing 30 ml by apparent volume of the alkali metal salt or alkaline earth metal salt into a 50-ml measuring cylinder and calculating the apparent specific gravity from the mass.

The d50 of the alkali metal salt or alkaline earth metal salt is preferably less than 10 μm, more preferably 4.5 μm or less, still more preferably 1.5 μm or less, particularly preferably less than 0.75 μm, while it is preferably 0.05 μm or more, more preferably 0.45 μm or more. When the d50 is within the range indicated above, the advantageous effect tends to be better achieved.

Here, the d50 of the alkali metal salt or alkaline earth metal salt refers to a particle size corresponding to the 50th percentile of a mass-based particle size distribution curve obtained by a laser diffraction method.

The nitrogen adsorption specific surface area (N₂SA) of the alkali metal salt or alkaline earth metal salt is preferably 100 m²/g or more, more preferably 115 m²/g or more, while it is preferably 250 m²/g or less, more preferably 225 m²/g or less, still more preferably 200 m²/g or less. When the N₂SA is within the range indicated above, the advantageous effect tends to be better achieved.

Here, the N₂SA of the alkali metal salt or alkaline earth metal salt is measured by the BET method in accordance with JIS Z 8830:2013.

Usable commercial products of the alkali metal salt or alkaline earth metal salt are available from Kyowa Chemical Industry, FUJIFILM Wako Pure Chemical Corporation, KISHIDA CHEMICAL Co., Ltd., Kyowa Chemical Industry, Tateho Chemical Industries Co., Ltd., JHE Co., Ltd, Nippon Chemical Industrial Co., Ltd, Ako Kasei Co., Ltd., etc.

### (Filler)

The rubber composition desirably contains filler. Examples of the filler include materials known in the rubber field, including inorganic fillers such as silica, carbon black, calcium carbonate, talc, alumina, clay, aluminum hydroxide, aluminum oxide, and mica; and hard-to-disperse fillers. Silica and carbon black are preferred among these.

Non-limiting examples of silica include dry silica (anhydrous silica) and wet silica (hydrous silica). Wet silica is preferred among these because it contains a large number of silanol groups. Examples of usable silica other than anhydrous silica and hydrous silica include silica produced from biomass materials such as rice husks. These may be used alone or in combinations of two or more.

The average primary particle size of the silica is preferably 25 nm or less, more preferably 18 nm or less, still more preferably 17 nm or less, particularly preferably 15 nm or less. The lower limit of the average primary particle size is not limited, and it is preferably 3 nm or more, more preferably 5 nm or more, still more preferably 7 nm or more. When the average primary particle size is within the range indicated above, the advantageous effect tends to be more suitably achieved.

Here, the average primary particle size of the silica may be determined by observing the silica using a transmission or scanning electron microscope to measure at least 400 primary particles of the silica observed in the visual field, and averaging the measurements.

The mechanism for the advantageous effect is not completely clear, but it is assumed as follows.

Silica having an average primary particle size of a predetermined size or less, particularly 18 nm or less, provides a higher reinforcing effect. Use of such a silica can suppress a reduction in the block rigidity even in driving on a dry road surface after driving on a wet road surface without losing grip, presumably whereby good grip performance can be obtained. Thus, presumably, changes in performances caused by changes in road conditions from dry to wet road surface or from wet to dry road surface can be suppressed.

Usable commercial products of silica are available from Evonik Degussa, Rhodia, Tosoh Silica Corporation, Solvay Japan, Tokuyama Corporation, etc.

The amount of silica per 100 parts by mass of the rubber component in the rubber composition is preferably 20 parts by mass or more, more preferably 40 parts by mass or more, still more preferably 55 parts by mass or more, particularly preferably 65 parts by mass or more. The upper limit of the amount is not limited, and it is preferably 150 parts by mass or less, more preferably 100 parts by mass or less, still more preferably 90 parts by mass or less. When the amount is within the range indicated above, the advantageous effect can be suitably achieved.

When the rubber composition contains silica, it preferably further contains a silane coupling agent.

The silane coupling agent may be any silane coupling agent. Examples include sulfide silane coupling agents such as bis(3-triethoxysilylpropyl) tetrasulfide, bis(2-triethoxysilylethyl) tetrasulfide, bis(4-triethoxysilylbutyl) tetrasulfide, bis(3-trimethoxysilylpropyl) tetrasulfide, bis(2-trimethoxysilylethyl) tetrasulfide, bis(2-triethoxysilylethyl) trisulfide, bis(4-trimethoxysilylbutyl) trisulfide, bis(3-triethoxysilylpropyl)disulfide, bis(2-triethoxysilylethyl)disulfide, bis(4-triethoxysilylbutyl)disulfide, bis(3-trimethoxysilylpropyl)disulfide, bis(2-trimethoxysilylethyl)disulfide, bis(4-trimethoxysilylbutyl)disulfide, 3-trimethoxysilylpropyl-N,N-dimethylthiocarbamoyltetrasulfide, 2-triethoxysilylethyl-N,N-dimethylthiocarbamoyltetrasulfide, and 3-triethoxysilylpropyl methacrylate monosulfide; mercapto silane coupling agents such as 3-mercaptopropyltrimethoxysilane and 2-mercaptoethyltriethoxysilane; vinyl silane coupling agents such as vinyltriethoxysilane and vinyltrimethoxysilane; amino silane coupling agents such as 3-aminopropyltriethoxysilane and 3-aminopropyltrimethoxysilane; glycidoxy silane coupling agents such as γ-glycidoxypropyltriethoxysilane and γ-glycidoxypropyltrimethoxysilane; nitro silane coupling agents such as 3-nitropropyltrimethoxysilane and 3-nitropropyltriethoxysilane; and chloro silane coupling agents such as 3-chloropropyltrimethoxysilane and 3-chloropropyltriethoxysilane. Usable commercial products are available from Evonik Degussa, Momentive, Shin-Etsu Silicone, Tokyo Chemical Industry Co., Ltd., AZmax. Co., Dow Corning Toray Co., Ltd., etc. These may be used alone or in combinations of two or more.

In order to suitably achieve the advantageous effect, mercapto silane coupling agents are desirable.

Suitable examples of the mercapto silane coupling agents include compounds having a mercapto group as well as compounds in which a mercapto group is protected by a protecting group (for example, compounds represented by the formula (S1) below).

Examples of particularly suitable mercapto silane coupling agents include silane coupling agents represented by the formula (S1) below and silane coupling agents containing linking units A and B represented by Formulas (I) and (II), respectively, below.

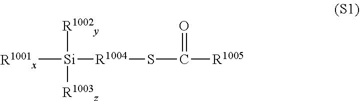

In the formula, R¹⁰⁰¹ represents a monovalent group selected from —Cl, —Br, —OR¹⁰⁰⁶, —O(O═) CR¹⁰⁰⁶, —ON═CR¹⁰⁰⁶R¹⁰⁰⁷, —NR¹⁰⁰⁶R¹⁰⁰⁷, and —(OSiR¹⁰⁰⁶R¹⁰⁰⁷)ₕ(OSiR¹⁰⁰⁶R¹⁰⁰⁷R¹⁰⁰⁸) where R¹⁰⁰⁶, R¹⁰⁰⁷, and R¹⁰⁰⁸ may be the same or different and each represent a hydrogen atom or a C1-C18 monovalent hydrocarbon group, and h is 1 to 4 on average; R¹⁰⁰² represents R¹⁰⁰¹, a hydrogen atom, or a C1-C18 monovalent hydrocarbon group; R¹⁰⁰³ represents a —[O(R¹⁰⁰⁹O)ⱼ]— group where R¹⁰⁰⁹ represents a C1-C18 alkylene group, and j represents an integer of 1 to 4; R¹⁰⁰⁴ represents a C1-C18 divalent hydrocarbon group; R¹⁰⁰⁵ represents a C1-C18 monovalent hydrocarbon group; and x, y, and z are numbers satisfying the following relationships: x+y+2z=3, 0≤x≤3, 0≤y≤2, and 0≤z≤1.

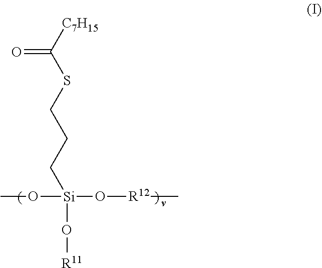

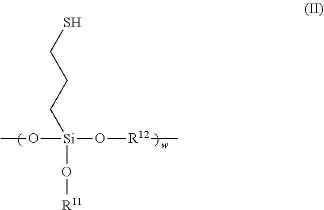

In the formulas, v represents an integer of 0 or more; w represents an integer of 1 or more; R¹¹ represents a hydrogen atom, a halogen atom, a branched or unbranched C1-C30 alkyl group, a branched or unbranched C2-C30 alkenyl group, a branched or unbranched C2-C30 alkynyl group, or the alkyl group in which a terminal hydrogen atom is replaced with a hydroxy or carboxy group; R¹² represents a branched or unbranched C1-C30 alkylene group, a branched or unbranched C2-C30 alkenylene group, or a branched or unbranched C2-C30 alkynylene group; and R¹¹ and R¹² may together form a ring structure.

Preferably, R¹⁰⁰⁵, R¹⁰⁰⁶, R¹⁰⁰⁷, and R¹⁰⁰⁸ in the formula (S1) each independently represent a group selected from the group consisting of C1-C18 linear, cyclic, or branched alkyl, alkenyl, aryl, and aralkyl groups. Moreover, when R¹⁰⁰² is a C1-C18 monovalent hydrocarbon group, it is preferably a group selected from the group consisting of an alkyl group, an alkenyl group, an aryl group, and an aralkyl group which may be linear, cyclic, or branched. R¹⁰⁰⁹ is preferably a linear, cyclic, or branched alkylene group, particularly preferably a linear alkylene group. Examples of R¹⁰⁰⁴ include C1-C18 alkylene groups, C2-C18 alkenylene groups, C5-C18 cycloalkylene groups, C6-C18 cycloalkylalkylene groups, C6-C18 arylene groups, and C7-C18 aralkylene groups. The alkylene groups or alkenylene groups may be either linear or branched. The cycloalkylene groups, the cycloalkylalkylene groups, the arylene groups, or the aralkylene groups may have a functional group such as a lower alkyl group on the ring. The R¹⁰⁰⁴ is preferably a C1-C6 alkylene group, particularly preferably a linear alkylene group such as a methylene group, an ethylene group, a trimethylene group, a tetramethylene group, a pentamethylene group, or a hexamethylene group.

Specific examples of R¹⁰⁰², R¹⁰⁰⁵, R¹⁰⁰⁶, R¹⁰⁰⁷, and R¹⁰⁰⁸ in the formula (S1) include a methyl group, an ethyl group, a n-propyl group, an isopropyl group, a n-butyl group, an isobutyl group, a sec-butyl group, a tert-butyl group, a pentyl group, a hexyl group, an octyl group, a decyl group, a dodecyl group, a cyclopentyl group, a cyclohexyl group, a vinyl group, a propenyl group, an allyl group, a hexenyl group, an octenyl group, a cyclopentenyl group, a cyclohexenyl group, a phenyl group, a tolyl group, a xylyl group, a naphthyl group, a benzyl group, a phenethyl group, and a naphthylmethyl group.

With regard to R¹⁰⁰⁹ in the formula (S1), examples of the linear alkylene group include a methylene group, an ethylene group, a n-propylene group, a n-butylene group, and a hexylene group, and examples of the branched alkylene group include an isopropylene group, an isobutylene group, and a 2-methylpropylene group.

Specific examples of the silane coupling agents represented by the formula (S1) include 3-hexanoylthiopropyltriethoxysilane, 3-octanoylthiopropyltriethoxysilane, 3-decanoylthiopropyltriethoxysilane, 3-lauroylthiopropyltriethoxysilane, 2-hexanoylthioethyltriethoxysilane, 2-octanoylthioethyltriethoxysilane, 2-decanoylthioethyltriethoxysilane, 2-lauroylthioethyltriethoxysilane, 3-hexanoylthiopropyltrimethoxysilane, 3-octanoylthiopropyltrimethoxysilane, 3-decanoylthiopropyltrimethoxysilane, 3-lauroylthiopropyltrimethoxysilane, 2-hexanoylthioethyltrimethoxysilane, 2-octanoylthioethyltrimethoxysilane, 2-decanoylthioethyltrimethoxysilane, and 2-lauroylthioethyltrimethoxysilane. These may be used alone or in combinations of two or more. Particularly preferred among these is 3-octanoylthiopropyltriethoxysilane.

The linking unit A content of the silane coupling agents containing linking units A and B represented by Formulas (I) and (II), respectively, is preferably 30 mol % or higher, more preferably 50 mol % or higher, still more preferably 55 mol % or higher, while it is preferably 99 mol % or lower, more preferably 90 mol % or lower. The linking unit B content thereof is preferably 1 mol % or higher, more preferably 5 mol % or higher, still more preferably 10 mol % or higher, while it is preferably 70 mol % or lower, more preferably 65 mol % or lower, still more preferably 55 mol % or lower, further preferably 45 mol % or lower. Moreover, the combined content of the linking units A and B is preferably 95 mol % or higher, more preferably 98 mol % or higher, particularly preferably 100 mol %.

Here, the linking unit A or B content refers to the amount including the linking unit A or B present at the end of the silane coupling agent, if any. When the linking unit A or B is present at the end of the silane coupling agent, its form is not limited as long as it forms a unit corresponding to Formula (I) or (II) representing the linking unit A or B.

With regard to R¹¹ in Formulas (I) and (II), examples of the halogen atom include chlorine, bromine, and fluorine; examples of the branched or unbranched C1-C30 alkyl group include a methyl group and an ethyl group; examples of the branched or unbranched C2-C30 alkenyl group include a vinyl group and a 1-propenyl group; and examples of the branched or unbranched C2-C30 alkynyl group include an ethynyl group and a propynyl group.

With regard to R¹² in Formulas (I) and (II), examples of the branched or unbranched C1-C30 alkylene group include an ethylene group and a propylene group; examples of the branched or unbranched C2-C30 alkenylene group include a vinylene group and a 1-propenylene group; and examples of the branched or unbranched C2-C30 alkynylene group include an ethynylene group and a propynylene group.

In the silane coupling agents containing linking units A and B represented by Formulas (I) and (II), respectively, the total number of repetitions (v+w) as the sum of the number of repetitions (v) of the linking unit A and the number of repetitions (w) of the linking unit B is preferably in the range of 3 to 300.

The amount of silane coupling agents per 100 parts by mass of silica in the rubber composition is preferably 3.0 parts by mass or more, more preferably 6.0 parts by mass or more, still more preferably 8.0 parts by mass or more, particularly preferably 9.0 parts by mass or more. The amount is preferably 25.0 parts by mass or less, more preferably 20.0 parts by mass or less, still more preferably 17.0 parts by mass or less, further preferably 16.0 parts by mass or less, further preferably 15.0 parts by mass or less, further preferably 12.0 parts by mass or less. When the amount is within the range indicated above, the advantageous effect can be suitably achieved.

Examples of usable carbon black include N134, N110, N220, N234, N219, N339, N330, N326, N351, N550, and N762. In addition to carbon black obtained by burning mineral oils, carbon black obtained by burning biomass-derived materials such as lignin may also be appropriately used. These may be used alone or in combination of two or more. Usable commercial products may be available from Asahi Carbon Co., Ltd., Cabot Japan K.K., Tokai Carbon Co., Ltd., Mitsubishi Chemical Corporation, Lion Corporation, NSCC Carbon Co., Ltd., Columbia Carbon, etc.

The nitrogen adsorption specific surface area (N₂SA) of the carbon black is preferably 50 m²/g or more, more preferably 80 m²/g or more, still more preferably 100 m²/g or more, further preferably 114 m²/g or more. The N₂SA is preferably 200 m²/g or less, more preferably 150 m²/g or less, still more preferably 130 m²/g or less. When the N₂SA is within the range indicated above, the advantageous effect tends to be better achieved.

Here, the N₂SA of carbon black can be determined in accordance with JIS K 6217-2:2001.

The amount of carbon black per 100 parts by mass of the rubber component in the rubber composition is preferably 5 parts by mass or more, more preferably 7 parts by mass or more, still more preferably 10 parts by mass or more. The upper limit is preferably 30 parts by mass or less, more preferably 20 parts by mass or less, still more preferably 15 parts by mass or less. When the amount is within the range indicated above, the advantageous effect tends to be better achieved.

### (Plasticizer)

The rubber composition preferably contains a plasticizer. The term “plasticizer” refers to a material that can impart plasticity to rubber components. Examples include liquid plasticizers (plasticizers which are liquid at room temperature (25° C.)) and resins (resins which are solid at room temperature (25° C.)).

In order to better obtain the advantageous effect, the resin is desired among these.

The mechanism for the advantageous effect is not completely clear, but it is assumed as follows.

The addition of a plasticizer component allows the rubber surface to have a higher conformity to the road surface, presumably whereby grip performance can be increased both on a wet road surface and a dry road surface. Further, when the resin is added, the friction with the road surface is increased due to the viscosity of the resin component. Therefore, even in driving on a dry road surface after driving on a wet road surface, for example, a reduction in grip is suppressed due to the viscosity of the rubber surface, presumably whereby good grip performance can be obtained. Thus, presumably, changes in performances caused by changes in road conditions from dry to wet road surface or from wet to dry road surface can be suppressed.

The amount of the plasticizer (total amount of plasticizers) per 100 parts by mass of the rubber component in the rubber composition is preferably 5 parts by mass or more, more preferably 10 parts by mass or more, still more preferably 15 parts by mass or more, particularly preferably 20 parts by mass or more. The upper limit is preferably 80 parts by mass or less, more preferably 60 parts by mass or less, still more preferably 40 parts by mass or less, particularly preferably 30 parts by mass or less. When the amount is within the range indicated above, the advantageous effect tends to be better achieved.

Liquid plasticizers (plasticizers which are liquid at room temperature (25° C.)) usable in the rubber composition are not limited, and examples include oils and liquid polymers such as liquid resins, liquid diene-based polymers, and liquid farnesene-based polymers. These may be used alone or in combinations of two or more.

The amount of liquid plasticizers per 100 parts by mass of the rubber component in the rubber composition is preferably 3 parts by mass or more, more preferably 5 parts by mass or more, still more preferably 8 parts by mass or more, particularly preferably 10 parts by mass or more. The upper limit is preferably 50 parts by mass or less, more preferably 30 parts by mass or less, still more preferably 20 parts by mass or less. When the amount is within the range indicated above, the advantageous effect tends to be better achieved. Here, the amount of liquid plasticizers include the amount of oils contained in oil-extended rubbers. The amount of oils is also suitably within the range indicated above.

Examples of the oils include process oils, plant oils, and mixtures thereof. Examples of the process oils include paraffinic process oils, aromatic process oils, and naphthenic process oils. Examples of the plant oils include castor oil, cotton seed oil, linseed oil, rapeseed oil, soybean oil, palm oil, coconut oil, peanut oil, rosin, pine oil, pine tar, tall oil, corn oil, rice oil, safflower oil, sesame oil, olive oil, sunflower oil, palm kernel oil, camellia oil, jojoba oil, macadamia nut oil, and tung oil. Usable commercial products may be available from Idemitsu Kosan Co., Ltd., Sankyo Yuka Kogyo K.K., ENEOS Corporation, Olisoy, H&R, Hokoku Corporation, Showa Shell Sekiyu K.K., Fuji Kosan Co., Ltd., The Nisshin Oillio Group, etc. Process oils such as paraffinic process oils, aromatic process oils, and naphthenic process oils, and plant oils are preferred among these. From the standpoint of life cycle assessment, these process oils and plant oils may also be appropriately used after being used as lubricating oils in mixers for mixing rubber, engines, or the like or after becoming waste cooking oils.

Examples of the liquid resins include terpene resins (including terpene phenolic resins and aromatic modified terpene resins), rosin resins, styrene resins, C5 resins, C9 resins, C5/C9 resins, dicyclopentadiene (DCPD) resins, coumarone-indene resins (including resins based on coumarone or indene alone), phenolic resins, olefin resins, polyurethane resins, and acrylic resins. Hydrogenated products of these resins are also usable.

Examples of the liquid diene-based polymers include liquid styrene-butadiene copolymers (liquid SBR), liquid polybutadiene polymers (liquid BR), liquid polyisoprene polymers (liquid IR), liquid styrene-isoprene copolymers (liquid SIR), liquid styrene-butadiene-styrene block copolymers (liquid SBS block polymers), and liquid styrene-isoprene-styrene block copolymers (liquid SIS block polymers), all of which are liquid at 25° C. The chain ends or backbones of these polymers may be modified with a polar group. Hydrogenated products of these polymers are also usable.

In the rubber composition, the reversible changes with water in E* and in tan δ represented by the formula (1) and the formula (2) can also be achieved by using a combination of a modified liquid diene-based polymer containing at least one selected from the group consisting of carboxylic acid, sulfonic acid, and salts thereof in its molecule with the alkali metal salt or alkaline earth metal salt, instead of the combination of the modified rubber and the alkali metal salt or alkaline earth metal salt. The combination of the modified liquid diene-based polymer and the alkali metal salt or alkaline earth metal salt can also provide the same advantageous effect due to the mechanism in the case of the combination of the modified rubber and the alkali metal salt or alkaline earth metal salt.

The modification of the modified liquid diene-based polymer is as described for the modification of the modified rubber.

The modified liquid diene-based polymer contains at least one ionic functional group selected from the group consisting of carboxylic acid, sulfonic acid, and salts thereof in its molecule. The number of the functional group per molecule is preferably 1 to 100, more preferably 2 to 50, still more preferably 5 to 25.

The number of the functional group per molecule can be determined by performing infrared absorption spectrometry and calculating the number based on the peak corresponding to the functional group.

The number average molecular weight of the modified liquid diene-based polymer is preferably 1000 to 50000, more preferably 1500 to 40000, still more preferably 2000 to 35000.

Here, the number average molecular weight can be determined by gel permeation chromatography (GPC) using a calibration curve based on standard polystyrene.

When the modified liquid diene-based polymer is used, the rubber composition may not contain the modified rubber as a rubber component and contains a different rubber component other than the modified rubber instead as well as a combination of the modified liquid diene-based polymer with the alkali metal salt or alkaline earth metal salt. Alternatively, the rubber composition may contain the modified rubber as a rubber component and also contains a combination of the modified liquid diene-based polymer with the alkali metal salt or alkaline earth metal salt.

In order to suitably achieve the advantageous effect, the modified liquid diene-based polymer is preferably a modified liquid IR containing at least one selected from the group consisting of carboxylic acid, sulfonic acid, and salts thereof in its molecule, more preferably a liquid IR containing methacrylic acid or maleic acid in its molecule.

The amount of the modified liquid diene-based polymer, if present, in the rubber composition per 100 parts by mass of the rubber component is preferably 5 parts by mass or more, more preferably 10 parts by mass or more, still more preferably 15 parts by mass or more, particularly preferably 20 parts by mass or more. The amount is preferably 50 parts by mass or less, more preferably 40 parts by mass or less, still more preferably 35 parts by mass or less, particularly preferably 30 parts by mass or less. When the amount is within the range indicated above, the advantageous effect can be suitably achieved.

Examples of the liquid farnesene-based polymers include liquid farnesene polymers and liquid farnesene-butadiene copolymers, all of which are liquid at 25° C. The chain ends or backbones of these may be modified with a polar group. Hydrogenated products of these are also usable.

Examples of the resin (resin which is solid at room temperature (25° C.)) usable in the rubber composition include aromatic vinyl polymers, coumarone-indene resin, coumarone resin, indene resin, phenol resin, rosin resin, petroleum resins, terpene-based resins, and acrylic resins, all of which are solid at room temperature (25° C.). The resin may be hydrogenated. These may be used alone or in combinations of two or more. Aromatic vinyl polymers, petroleum resins, and terpene-based resins are preferred among these.

The amount of the resin per 100 parts by mass of the rubber component in the rubber composition is preferably 5 parts by mass or more, more preferably 8 parts by mass or more, still more preferably 10 parts by mass or more. The upper limit is preferably 50 parts by mass or less, more preferably 30 parts by mass or less, still more preferably 20 parts by mass or less. When the amount is within the range indicated above, the advantageous effect tends to be better achieved.

The softening point of the resin is preferably 50° C. or higher, more preferably 55° C. or higher, still more preferably 60° C. or higher, further preferably 85° C. or higher. The upper limit is preferably 160° C. or lower, more preferably 150° C. or lower, still more preferably 145° C. or lower. When the softening point is within the range indicated above, the advantageous effect tends to be better achieved.

Here, the softening point of the resin is measured in accordance with JIS K 6220-1:2001 using a ring and ball softening point measuring apparatus, and the temperature at which the ball drops down is defined as the softening point.

Here, the softening point of the resin is usually about +50° C.±5° C. of the glass transition temperature of the resin component.

The aromatic vinyl polymers refer to polymers containing aromatic vinyl monomers as structural units. Examples include resins produced by polymerizing γ-methylstyrene and/or styrene. Specific examples include styrene homopolymers (styrene resins), α-methylstyrene homopolymers (α-methylstyrene resins), copolymers of α-methylstyrene and styrene, and copolymers of styrene and other monomers.

The coumarone-indene resins refer to resins containing coumarone and indene as the main monomer components forming the skeleton (backbone) of the resins.

Examples of monomer components which may be contained in the skeleton in addition to coumarone and indene include styrene, α-methylstyrene, methylindene, and vinyltoluene.

The coumarone resins refer to resins containing coumarone as the main monomer component forming the skeleton (backbone) of the resins.

The indene resins refer to resins containing indene as the main monomer component forming the skeleton (backbone) of the resins.

Examples of the phenol resins include known polymers produced by reacting phenol with an aldehyde such as formaldehyde, acetaldehyde, or furfural in the presence of an acid or alkali catalyst. Preferred among these are those produced by the reaction in the presence of an acid catalyst, such as novolac phenol resins.

Examples of the rosin resins include rosin resins typified by natural rosins, polymerized rosins, modified rosins, and esterified compounds thereof, and hydrogenated products thereof.

Examples of the petroleum resins include C5 resins, C9 resins, C5/C9 resins, dicyclopentadiene (DCPD) resins, and hydrogenated products of these resins. DCPD resins and hydrogenated DCPD resins are preferred among these.

The terpene resins refer to polymers containing terpene as a structural unit. Examples include polyterpene resins produced by polymerizing terpene compounds, and aromatic modified terpene resins produced by polymerizing terpene compounds and aromatic compounds. Examples of usable aromatic modified terpene resins include terpene-phenol resins made from terpene compounds and phenolic compounds, terpene-styrene resins made from terpene compounds and styrene compounds, and terpene-phenol-styrene resins made from terpene compounds, phenolic compounds, and styrene compounds. Examples of terpene compounds include α-pinene and β-pinene. Examples of phenolic compounds include phenol and bisphenol A. Examples of aromatic compounds include styrene compounds such as styrene and α-methylstyrene.

The acrylic resins refer to polymers containing acrylic monomers as structural units. Examples include styrene acrylic-based resins, such as styrene acrylic resins, which contain carboxy groups and are produced by copolymerizing aromatic vinyl monomer components and acrylic monomer components. Solvent-free, carboxy group-containing styrene acrylic-based resins are suitably usable among these.

Examples of usable commercial plasticizers include products available from Maruzen Petrochemical Co., Ltd., Sumitomo Bakelite Co., Ltd., Yasuhara Chemical Co., Ltd., TOSOH Corporation, Rutgers Chemicals, BASF, Arizona Chemical, Nitto Chemical Co., Ltd., Nippon Shokubai Co., Ltd., ENEOS Corporation, Arakawa Chemical Industries, Ltd., Taoka Chemical Co., Ltd., etc.

### (Vulcanizing Agent)

The rubber composition preferably contains a vulcanizing agent to moderately form crosslinks between the polymer chains to build a network, thereby better achieving the advantageous effect.

Examples of the vulcanizing agent include sulfur.

Examples of sulfur include those commonly used in the rubber industry, such as powdered sulfur, precipitated sulfur, colloidal sulfur, insoluble sulfur, highly dispersible sulfur, and soluble sulfur. Usable commercial products are available from Tsurumi Chemical Industry Co., Ltd., Karuizawa sulfur Co., Ltd., Shikoku Chemicals Corporation, Flexsys, Nippon Kanryu Industry Co., Ltd., Hosoi Chemical Industry Co., Ltd., etc. These may be used alone or in combinations of two or more.

The amount of vulcanizing agents (preferably the amount of sulfur) per 100 parts by mass of the rubber component in the rubber composition is preferably 1.0 parts by mass or more, more preferably 1.5 parts by mass or more, still more preferably 1.8 parts by mass or more, further preferably 2.0 parts by mass or more, further preferably 2.5 parts by mass or more, further preferably 2.8 parts by mass or more, further preferably 3.0 parts by mass or more. The amount is preferably 8.0 parts by mass or less, more preferably 6.0 parts by mass or less, still more preferably 5.0 parts by mass or less, particularly preferably 4.0 parts by mass or less.

### (Vulcanization Accelerator)

The rubber composition desirably contains a vulcanization accelerator to favorably form a network in the rubber so that the advantageous effect can be well achieved.

The amount of vulcanization accelerators per 100 parts by mass of the rubber component in the rubber composition is preferably 1.0 parts by mass or more, more preferably 3.0 parts by mass or more, still more preferably 3.5 parts by mass or more, particularly preferably 3.9 parts by mass or more. The amount is preferably 12.0 parts by mass or less, more preferably 10.0 parts by mass or less, still more preferably 9.0 parts by mass or less, particularly preferably 7.0 parts by mass or less.

Any type of vulcanization accelerator may be used, including usually used ones. Examples of vulcanization accelerators include thiazole vulcanization accelerators such as 2-mercaptobenzothiazole, di-2-benzothiazolyl disulfide, and N-cyclohexyl-2-benzothiazylsulfenamide; thiuram vulcanization accelerators such as tetramethylthiuram disulfide (TMTD), tetrabenzylthiuram disulfide (TBzTD), and tetrakis(2-ethylhexyl)thiuram disulfide (TOT-N); sulfenamide vulcanization accelerators such as N-cyclohexyl-2-benzothiazole sulfenamide, N-t-butyl-2-benzothiazolylsulfenamide, N-oxyethylene-2-benzothiazole sulfenamide, and N,N′-diisopropyl-2-benzothiazole sulfenamide; and guanidine vulcanization accelerators such as diphenylguanidine, diorthotolylguanidine, and orthotolylbiguanidine. These may be used alone or in combination of two or more. Sulfenamide vulcanization accelerators and guanidine vulcanization accelerators are preferred among these.

Sulfenamide vulcanization accelerators and guanidine vulcanization accelerators are preferred among the vulcanization accelerators. The amount of sulfenamide vulcanization accelerators per 100 parts by mass of the rubber component is preferably 0.8 parts by mass or more, more preferably 1.3 parts by mass or more, still more preferably 1.6 parts by mass or more, while it is preferably 5.0 parts by mass or less, more preferably 4.0 parts by mass or less, still more preferably 3.0 parts by mass or less. The amount of guanidine vulcanization accelerators per 100 parts by mass of the rubber component is preferably 1.5 parts by mass or more, more preferably 2.0 parts by mass or more, still more preferably 2.3 parts by mass or more, while it is preferably 6.0 parts by mass or less, more preferably 5.0 parts by mass or less, still more preferably 4.0 parts by mass or less.

### (Other Components)

From the standpoint of properties such as cracking resistance and ozone resistance, the rubber composition preferably contains an antioxidant.

Non-limiting examples of the antioxidant include naphthylamine antioxidants such as phenyl-α-naphthylamine; diphenylamine antioxidants such as octylated diphenylamine and 4,4′-bis(α,α′-dimethylbenzyl)diphenylamine; p-phenylenediamine antioxidants such as N-isopropyl-N′-phenyl-p-phenylenediamine, N-(1,3-dimethylbutyl)-N′-phenyl-p-phenylenediamine, and N,N′-di-2-naphthyl-p-phenylenediamine; quinoline antioxidants such as polymerized 2,2,4-trimethyl-1,2-dihydroquinoline; monophenolic antioxidants such as 2,6-di-t-butyl-4-methylphenol and styrenated phenol; and bis-, tris-, or polyphenolic antioxidants such as tetrakis[methylene-3-(3′,5′-di-t-butyl-4′-hydroxyphenyl)propionate]methane. Preferred among these are p-phenylenediamine antioxidants and quinoline antioxidants, and more preferred are N-(1,3-dimethylbutyl)-N′-phenyl-p-phenylenediamine and polymerized 2,2,4-trimethyl-1,2-dihydroquinoline. Usable commercial products may be available from Seiko Chemical Co., Ltd., Sumitomo Chemical Co., Ltd., Ouchi Shinko Chemical Industrial Co., Ltd., Flexsys, etc.

The amount of antioxidants per 100 parts by mass of the rubber component in the rubber composition is preferably 0.2 parts by mass or more, more preferably 0.5 parts by mass or more, still more preferably 2.8 parts by mass or more. The amount is preferably 7.0 parts by mass or less, more preferably 4.0 parts by mass or less.

The rubber composition may contain stearic acid. The amount of stearic acid per 100 parts by mass of the rubber component in the rubber composition is preferably 0.5 to 10 parts by mass, more preferably 0.5 to 5 parts by mass, still more preferably 2 to 5 parts by mass.

The stearic acid may be conventional one. Usable commercial products may be available from NOF Corporation, Kao Corporation, FUJIFILM Wako Pure Chemical Corporation, Chiba Fatty Acid Co., Ltd., etc.

The rubber composition may contain zinc oxide.

The amount of zinc oxide per 100 parts by mass of the rubber component in the rubber composition is preferably 0.5 to 10 parts by mass, more preferably 1 to 5 parts by mass.

The zinc oxide may be conventional one. Usable commercial products may be available from Mitsui Mining & Smelting Co., Ltd., Toho Zinc Co., Ltd., HakusuiTech Co., Ltd., Seido Chemical Industry Co., Ltd., Sakai Chemical Industry Co., Ltd., etc.

The rubber composition may contain wax. The amount of wax per 100 parts by mass of the rubber component in the rubber composition is preferably 0.5 to 10 parts by mass, more preferably 1 to 5 parts by mass.

Non-limiting examples of the wax include petroleum waxes and natural waxes and also include synthetic waxes prepared by purifying or chemically treating a plurality of waxes. Each of these waxes may be used alone or in combination of two or more.

Examples of the petroleum waxes include paraffin waxes and microcrystalline waxes. The natural waxes may be any wax derived from non-petroleum resources, and examples include plant waxes such as candelilla wax, carnauba wax, Japan wax, rice wax, and jojoba wax; animal waxes such as beeswax, lanolin, and spermaceti; mineral waxes such as ozokerite, ceresin, and petrolatum; and purified products of these waxes. Usable commercial products may be available from Ouchi Shinko Chemical Industrial Co., Ltd., Nippon Seiro Co., Ltd., Seiko Chemical Co., Ltd., etc.

The rubber composition may contain other appropriate additives usually used in the application field, such as a release agent or a pigment, in addition to the above-described components.

The rubber composition may be prepared, for example, by kneading the components using a rubber kneading machine such as an open roll mill or a Banbury mixer, and then vulcanizing the kneaded mixture.

The kneading conditions are as follows. In a base kneading step of kneading additives other than vulcanizing agents and vulcanization accelerators, the kneading temperature is usually 100° C. to 180° C., preferably 120° C. to 170° C. In a final kneading step of kneading vulcanizing agents and vulcanization accelerators, the kneading temperature is usually 120° C. or lower, preferably 80° C. to 115° C., more preferably 85° C. to 110° C. Then, the composition obtained after kneading vulcanizing agents and vulcanization accelerators is usually vulcanized by, for example, press vulcanization. The vulcanization temperature is usually 140° C. to 190° C., preferably 150° C. to 185° C. The vulcanization time is usually 5 to 15 minutes.

The rubber composition is suitably usable in a tire component.

The tire component is not limited and may be any tire component, such as a cap tread, a sidewall, a base tread, a bead apex, a clinch apex, an innerliner, an under tread, a braker topping, or a ply topping. The rubber composition is especially suitably usable in a cap tread.

### <Tire>

The tire of the present disclosure includes a tire component including the rubber composition. Desirably, the tire component is a tread.

Examples of the tire applicable for the present disclosure include pneumatic tires and non-pneumatic tires. Of these, the tire is preferably a pneumatic tire. In particular, the tire can be suitably used as a summer tire a winter tire (studless tire, snow tire, studded tire, etc.), or an all-season tire. The tire can be used for passenger cars, large passenger cars, large SUVs, heavy-duty vehicles such as trucks and buses, light trucks, or motorcycles, or as a racing tire (high performance tire), etc. Of these, the tire is desirably used as a passenger car tire.

The tire may be produced using the above-described rubber composition by usual methods. For example, an unvulcanized rubber composition containing various materials is extruded into the shape of a tread and formed together with other tire components in a usual manner on a tire building machine to build an unvulcanized tire. Then, the unvulcanized tire is heated and pressurized in a vulcanizer, whereby a tire can be produced.

In the tire of the present disclosure, the thickness G (mm) of the tread measured on the equator in a radial cross-section of the tire is preferably 15.0 mm or less, more preferably 10.0 mm or less, still more preferably 9.0 mm or less, particularly preferably 8.0 mm or less. The lower limit is preferably 5.0 mm or more, more preferably 5.5 mm or more, still more preferably 6.0 mm or more, particularly preferably 6.5 mm or more. When the thickness G is within the range indicated above, the advantageous effect tends to be better achieved.

In the present disclosure, the term “thickness G of the tread measured on the equator in a radial cross-section of the tire” refers to the distance from the tread surface to the interface of the belt-reinforcing layer, belt layer, carcass layer, or other reinforcing layer containing a fiber material, which is outermost with respect to the tire, as measured on the equator in a cross-section taken along a plane including the rotational axis of the tire. Here, when the tread portion has a groove on the equator of the tire, the thickness G is the linear distance from the intersection of the equator and a straight line connecting the edges of the groove which are outermost in the radial direction of the tire.

The mechanism for the advantageous effect is not completely clear, but it is assumed as follows.

When the thickness G is a predetermined thickness or less, in particular, 9.0 mm or less, only the modulus of elasticity of the rubber at or near the surface decreases under wet conditions. When the thickness is 9.0 mm or less, the rigidity of the entire tread portion can be maintained. Therefore, generation of reaction force can be facilitated without losing grip performance. Thus, presumably, changes in performances caused by changes in road conditions from dry to wet road surface or from wet to dry road surface can be suppressed.

The thickness Gc of the rubber layer of the tread measured on the equator of the tire is preferably 12.0 mm or less, more preferably 10.0 mm or less, still more preferably 9.0 mm or less, particularly preferably 8.0 mm or less. The lower limit is preferably 2.0 mm or more, more preferably 3.0 mm or more, still more preferably 4.0 mm or more.

Here, Gc can be measured as described for the thickness G of the tread measured on the equator in a radial cross-section of the tire, and can be determined by measuring the distance from the outermost tread surface to the interface of the rubber layer formed of the above-described rubber composition, which is innermost with respect to the tire.

In the tire of the present disclosure, the groove depth D of the circumferential groove formed on the tread is preferably 13.0 mm or less, more preferably 10.0 mm or less, still more preferably 8.0 mm or less, further preferably 7.0 mm or less, further preferably 6.0 mm or less, while it is preferably 3.0 mm or more, more preferably 4.0 mm or more, still more preferably 5.0 mm or more. When the groove depth D is within the range indicated above, the advantageous effect tends to be better achieved.

Herein, the groove depth D of the circumferential groove refers to a distance measured along the normal of a plane extended from a ground contact face defining the outermost surface of the tread. The largest groove depth is a distance from the plane extended from the ground contact face to the deepest bottom, and it is the largest distance among the groove depths of the circumferential grooves provided.

In the tire of the present disclosure, the tread preferably has a negative ratio S (%) of 40% or lower.

The S is preferably 35% or lower, more preferably 30% or lower, still more preferably 25% or lower. The negative ratio is preferably 10% or higher, more preferably 15% or higher, still more preferably 20% or higher. When the negative ratio is within the range indicated above, the advantageous effect tends to be better achieved.

Here, the negative ratio (negative ratio within the ground contact face of the tread) refers to the ratio of the total groove area within the ground contact face to the total area of the ground contact face and is determined as described below.

Herein, when the tire is a pneumatic tire, the negative ratio is calculated from the contact patch of the tire under conditions including a normal rim, a normal internal pressure, and a normal load. In the case of a non-pneumatic tire, the negative ratio can be similarly determined without the need of the normal internal pressure.

The term “normal rim” refers to a rim specified for each tire by the standard in a standard system including standards according to which tires are provided, and may be, for example, the “standard rim” in JATMA, “design rim” in TRA, or “measuring rim” in ETRTO.

The term “normal internal pressure” refers to an air pressure specified for each tire by the standard and may be the maximum air pressure in JATMA, the maximum value shown in Table “TIRE LOAD LIMITS AT VARIOUS COLD INFLATION PRESSURES” in TRA, or the “inflation pressure” in ETRTO.

The term “normal load” refers to a load specified for each tire by the standard and may be the maximum load capacity in JATMA, the maximum value shown in Table “TIRE LOAD LIMITS AT VARIOUS COLD INFLATION PRESSURES” in TRA, or the “load capacity” in ETRTO.

The contact patch may be determined by mounting the tire on a normal rim, applying a normal internal pressure to the tire, allowing the tire to stand at 25° C. for 24 hours, applying black ink to the tread surface of the tire, and pressing the tread surface against a cardboard at a normal load (camber angle: 0°) for transfer to the cardboard.

The transfer is performed in five positions while rotating the tire by 72° each in the circumferential direction. Namely, the contact patch is obtained five times.

The contour points of each of the five contact patches are smoothly connected to draw a figure, the area of which is defined as the total area, and the transferred area as a whole corresponds to the ground contact area. The results of the five positions is averaged, and then the negative ratio (%) is calculated by the expression: [1−{Average of areas of five contact patches transferred to cardboard (parts with black ink)}/{Average of five total areas transferred to cardboard (figures obtained from contour points)}]×100(%).

Here, the average length and the average area are each the simple average of the five values.

In order to better achieve the advantageous effect, in the tire of the present disclosure, the 40% modulus (MPa) at 70° C. before a tensile test and the 40% modulus (MPa) at 70° C. after the tensile test of the rubber composition (vulcanized rubber composition) in the tread and the thickness G (mm) of the tread on the equator in a radial cross-section of the tire desirably satisfy the following formula:

[(40% modulus at 70° C. after tensile test/40% modulus at 70° C. before tensile test)/G]×100≥5.0

where 40% modulus at 70° C. after the tensile test refers to a tensile stress at an elongation of 40% determined after extension of 50% at 70° C., releasing the stress, and then measuring the tensile stress at an elongation of 40% at 70° C. in accordance with JIS K 6251:2010; and 40% modulus at 70° C. before a tensile test refers to a tensile stress at an elongation of 40% measured before the tensile test at 70° C. in accordance with JIS K 6251:2010.

The lower limit is preferably 5.2 or more, more preferably 5.3 or more, still more preferably 5.4 or more, further preferably 6.0 or more, further preferably 6.5 or more, further preferably 6.6 or more, further preferably 6.8 or more, further preferably 6.9 or more, further preferably 7.0 or more, further preferably 7.1 or more. The upper limit is preferably 8.5 or less, more preferably 8.0 or less, still more preferably 7.8 or less, further preferably 7.6 or less, further preferably 7.5 or less, particularly preferably 7.3 or less. When the upper and lower limits are within the range indicated above, the rigidity of the tread portion can be maintained while suppressing a reduction in the modulus, and also generation of reaction force can be facilitated. Thus, the advantageous effect tends to be better achieved.

In order to better achieve the advantageous effect, in the tire of the present disclosure, the 40% modulus (MPa) at 70° C. before a tensile test and the 40% modulus (MPa) at 70° C. after the tensile test of the rubber composition (vulcanized rubber composition) in the tread and the groove depth D (mm) of a circumferential groove formed on the tread desirably satisfy the following formula:

[(40% modulus at 70° C. after tensile test/40% modulus at 70° C. before tensile test)/D]×100≥8.0

where 40% modulus at 70° C. after the tensile test refers to a tensile stress at an elongation of 40% determined after extension of 50% at 70° C., releasing the stress, and then measuring the tensile stress at an elongation of 40% at 70° C. in accordance with JIS K 6251:2010; and 40% modulus at 70° C. before a tensile test refers to a tensile stress at an elongation of 40% measured before the tensile test at 70° C. in accordance with JIS K 6251:2010.

The lower limit is preferably 8.5 or more, more preferably 8.6 or more, still more preferably 8.7 or more, further preferably 8.8 or more, further preferably 9.0 or more, further preferably 9.2 or more, further preferably 9.3 or more, further preferably 9.5 or more, further preferably 9.7 or more. The upper limit is not limited, and it is preferably 15.0 or less, more preferably 12.0 or less, still more preferably 10.7 or less, further preferably 10.3 or less, further preferably 10.2 or less, further preferably 10.0 or less. When the upper and lower limits are within the range indicated above, the advantageous effect tends to be better achieved.

In order to better achieve the advantageous effect, in the tire of the present disclosure, the 40% modulus (MPa) at 70° C. before a tensile test and the 40% modulus (MPa) at 70° C. after the tensile test of the rubber composition (vulcanized rubber composition) in the tread and the negative ratio S (%) of the tread desirably satisfy the following formula:

[(40% modulus at 70° C. after tensile test/40% modulus at 70° C. before tensile test)/S]×100≥2.0

where 40% modulus at 70° C. after the tensile test refers to a tensile stress at an elongation of 40% determined after extension of 50% at 70° C., releasing the stress, and then measuring the tensile stress at an elongation of 40% at 70° C. in accordance with JIS K 6251:2010; and 40% modulus at 70° C. before a tensile test refers to a tensile stress at an elongation of 40% measured before the tensile test at 70° C. in accordance with JIS K 6251:2010.

The lower limit is preferably 2.1 or more, more preferably 2.2 or more. The upper limit is not limited, and it is preferably 10.0 or less, more preferably 7.0 or less, still more preferably 6.0 or less. When the upper and lower limits are within the range indicated above, the advantageous effect tends to be better achieved.

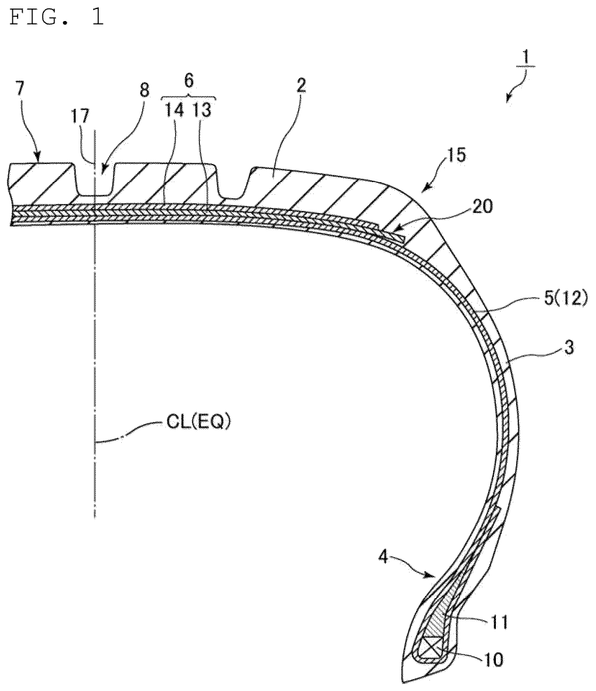

FIG. 1 shows a cross-sectional view of a part of a pneumatic tire 1 according to an embodiment of the present disclosure taken in the meridional direction of the tire. The tire of the present disclosure is not limited to the embodiment below.

In FIG. 1, the vertical direction corresponds to the radial direction of the tire (hereinafter, also referred to simply as radial direction), the horizontal direction corresponds to the axial direction of the tire (hereinafter, also referred to simply as axial direction), and the direction perpendicular to the paper corresponds to the circumferential direction of the tire (hereinafter, also referred to simply as circumferential direction). The tire 1 has a shape that is horizontally substantially symmetrical about a center line CL in FIG. 1. The center line CL is also referred to as a tread center line and defines the equator EQ of the tire 1.

The tire 1 includes a tread 2, a sidewall 3, a bead 4, a carcass 5, and a belt 6. The tire 1 is a tubeless tire.

The tread portion 2 includes a tread face 7. The tread face 7 has a radially outwardly convex shape in a cross-section taken in the meridional direction of the tire 1. The tread face 7 will contact the road surface. The tread face 7 has a plurality of circumferentially extending grooves 8 carved therein. The grooves 8 define a tread pattern. The external part of the tread 2 in the tire axial direction (tire width direction) is referred to as a shoulder portion 15. The sidewall 3 extends substantially inwardly in the radial direction from the end of the tread 2. The sidewall 3 consists of a cross-linked rubber or the like.

As shown in FIG. 1, the bead 4 is located radially substantially inward from the sidewall 3. The bead 4 includes a core 10 and an apex 11 radially outwardly extending from the core 10. The core 10 has a ring shape along the circumferential direction of the tire. The core 10 consists of a wound inextensible wire. Typically, a steel wire is used in the core 10. The apex 11 is radially outwardly tapered. The apex 11 consists of a very hard cross-linked rubber or the like.

In the present embodiment, the carcass 5 consists of a carcass ply 12. The carcass ply 12 extends between the opposite beads 4 along the inner sides of the tread 2 and the sidewalls 3. The carcass ply 12 is folded around the core 10 from the inside to the outside in the axial direction of the tire. Though not shown, the carcass ply 12 consists of a large number of parallel cords and a topping rubber. The absolute value of the angle of each cord relative to the equator EQ (CL) is usually 70° to 90°. In other words, the carcass 5 has a radial structure.

In the present embodiment, the belt 6 is located radially outward of the carcass 5. The belt 6 is stacked on the carcass 5. The belt 6 reinforces the carcass 5. The belt 6 may consist of an inner layer belt 13 and an outer layer belt 14. In the present embodiment, the widths of the belts 13 and 14 are different from each other.

Though not shown, the inner layer belt 13 and the outer layer belt 14 each usually consist of a large number of parallel cords and a topping rubber. Each cord is desirably inclined to the equator EQ. Desirably, the cords of the inner layer belt 13 are inclined in a direction opposite to that of the cords of the outer layer belt.

Though not shown, an embodiment may be used in which a band is stacked on the outer side of the belt 6 in the radial direction of the tire. The width of the band is larger than that of the belt 6. The band may consist of cords and a topping rubber. The cords are spirally wound. The belt is constrained by the cords, so that the belt 6 is inhibited from lifting. The cords desirably consist of organic fibers. Preferred examples of the organic fibers include nylon fibers, polyester fibers, rayon fibers, polyethylene naphthalate fibers, and aramid fibers.

Though not shown, an embodiment may be used in which an edge band is provided radially outward of the belt 6 and near the widthwise end (edge portion) of the belt 6. Like the band, the edge band may consist of cords and a topping rubber. An exemplary edge band may be stacked on the upper face of a step 20 of the wider inner layer belt 13. In an exemplary embodiment, the cords of the edge band are inclined in the same direction as the cords of the narrower outer layer belt 14 and are biased relative to the cords of the wider inner layer belt 13.

Though not shown, an embodiment may be used in which a cushion rubber layer is stacked on the carcass 5 near the widthwise end of the belt 6. In an exemplary embodiment, the cushion layer consists of a soft cross-linked rubber. The cushion layer absorbs the stress on the belt edge.

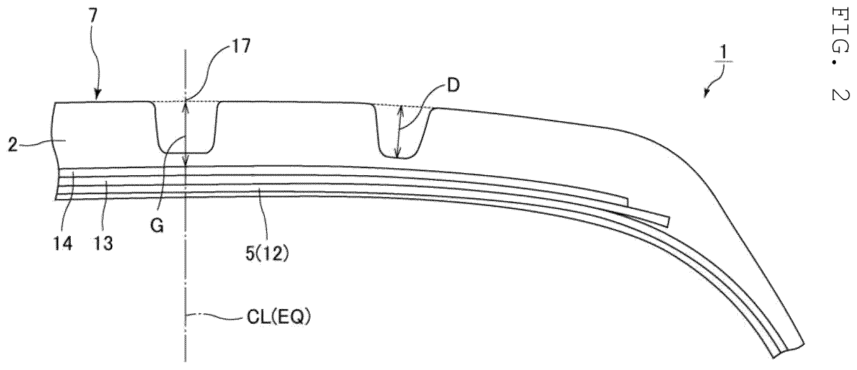

FIG. 2 shows a cross-sectional view of the tread 2 of the tire 1 taken along a plane including the tire axis. In FIGS. 1 and 2, a crown center 17 located at the equator EQ corresponds to “the equator in a cross-section of the tread 2 taken in the radial direction of the tire”.

In the tire 1, the E* when wet with water (MPa), the E* when dry (MPa), the tan δ when wet with water, the tan δ when dry, the 40% modulus (MPa) at 70° C. before a tensile test, and the 40% modulus (MPa) at 70° C. after the tensile test of the tread rubber composition (vulcanized rubber composition) in the tread 2 satisfy the formulas (1) to (3).

In the tire 1, the thickness G of the tread 2 measured on the equator in a radial cross-section of the tire refers to the distance from the tread surface 7 (which corresponds to a straight line connecting the edges of the groove 8 which are outermost in the radial direction of the tire because the tire 1 has the groove on the equator of the tire) to the interface of the outer layer belt 14, which is outermost with respect to the tire, as measured on the equator in a cross-section taken along a plane including the axis of the tire.

The tread 2 of the tire 1 is provided with circumferential grooves 8, and the groove depth D of the circumferential grooves 8 refers to a distance in the normal direction from a plane extended from a ground contact face defining the tread face 7 to the deepest bottom, and it is the depth of the deepest one of the multiple circumferential grooves 8.

In the tire 1, the E* when wet with water (MPa), the E* when dry (MPa), the tan δ when wet with water, the tan δ when dry, the 40% modulus (MPa) at 70° C. before a tensile test, and the 40% modulus (MPa) at 70° C. after the tensile test of the tread rubber composition (vulcanized rubber composition) in the tread 2, the thickness G (mm) of the tread on the equator in a radial cross-section of the tire, the groove depth D (mm) of the circumferential groove formed on the tread, and the negative ratio S (%) of the tread desirably satisfy the above-described formulas.

### EXAMPLES

The present disclosure will be specifically described with reference to, but not limited to, examples.

The chemicals used in examples and comparative examples are collectively described below.
Carboxylic acid-modified SBR: synthesized in Production Example 1 described below (carboxylic acid group content: 5% by mass, styrene content: 23% by mass, butadiene content: 72% by mass)
Carboxylic acid-modified BR: synthesized in Production Example 2 described below (carboxylic acid group content: 5% by mass, butadiene content: 95% by mass)
NR: TSR20
SBR: Nipol 1502 (E-SBR) available from ZEON Corporation
BR: BR730 (high-cis polybutadiene, cis content: 96% by mass) available from JSR Corporation
Carbon black: DIABLACK I (N220, N2SA: 114 m²/g, DBP: 114 ml/100 g) available from Mitsubishi Chemical Corporation
Silica 1: ULTRASIL VN3 (average primary particle size: 17 nm) available from Evonik Degussa
Silica 2: ULTRASIL 9100GR (average primary particle size: 15 nm) available from Evonik Degussa
Stearic acid: stearic acid “TSUBAKI” available from NOF Corporation
Potassium acetate: potassium acetate available from FUJIFILM Wako Pure Chemical Corporation
Calcium acetate: calcium acetate available from FUJIFILM Wako Pure Chemical Corporation
Zinc oxide: zinc oxide #1 available from Mitsui Mining & Smelting Co., Ltd.
Oil: VIVATEC 400/500 (TDAE oil) available from H&R
Silane coupling agent 1: Si69 (bis(3-triethoxysilylpropyl)tetrasulfide) available from EVONIK-DEGUSSA
Silane coupling agent 2: NXT-Z45 (a copolymer of linking units A and B, linking unit A: 55 mol %, linking unit B: 45 mol %) available from Momentive
Resin: SYLVARES SA85 (a copolymer of α-methylstyrene and styrene, Tg: 43° C., softening point: 85° C.) available from Arizona chemical
Antioxidant: Antigen 6C (antioxidant, N-(1,3-dimethylbutyl)-N′-phenyl-p-phenylenediamine) available from Sumitomo Chemical Co., Ltd.
Sulfur: powdered sulfur available from Tsurumi Chemical Industry Co., Ltd.
Vulcanization accelerator DPG: NOCCELER D (1,3-diphenyl guanidine) available from Ouchi Shinko Chemical Industrial Co., Ltd.
Vulcanization accelerator NS: NOCCELER NS (N-tert-butyl-2-benzothiazylsulfenamide) available from Ouchi Shinko Chemical Industrial Co., Ltd.

### Production Example 1: Synthesis of Carboxylic Acid-Modified SBR

### (Preparation of Latex)

An amount of 2000 g of distilled water, 45 g of emulsifier (1), 1.5 g of emulsifier (2), 8 g of an electrolyte, 250 g of styrene, 50 g of methacrylic acid, 700 g of polybutadiene, and 2 g of a molecular weight regulator were charged into a pressure-resistant reactor provided with a stirrer. The reactor temperature was set to 5° C. An aqueous solution containing 1 g of a radical initiator and 1.5 g of SFS dissolved therein and an aqueous solution containing 0.7 g of EDTA and 0.5 g of a catalyst dissolved therein were added to the reactor to initiate polymerization. Five hours after the initiation of polymerization, 2 g of a polymerization terminator was added to stop the reaction, whereby latex was prepared.

### (Preparation of Rubber)

Unreacted monomers were removed from the obtained latex by steam distillation. Then, the latex was added to alcohol and coagulated while the pH was adjusted to 3 to 5 with a saturated sodium chloride aqueous solution or formic acid to give a crumb polymer. The polymer was dried with a vacuum dryer at 40° C. to obtain a solid rubber (emulsion-polymerized rubber).

### Production Example 2: Synthesis of Carboxylic Acid-Modified BR

### (Preparation of Latex)

An amount of 2000 g of distilled water, 45 g of emulsifier (1), 1.5 g of emulsifier (2), 8 g of an electrolyte, 50 g of methacrylic acid, 950 g of polybutadiene, and 2 g of a molecular weight regulator were charged into a pressure-resistant reactor provided with a stirrer. The reactor temperature was set to 5° C. An aqueous solution containing 1 g of a radical initiator and 1.5 g of SFS dissolved therein and an aqueous solution containing 0.7 g of EDTA and 0.5 g of a catalyst dissolved therein were added to the reactor to initiate polymerization. Five hours after the initiation of polymerization, 2 g of a polymerization terminator was added to stop the reaction, whereby latex was prepared.

### (Preparation of Rubber)

Unreacted monomers were removed from the obtained latex by steam distillation. Then, the latex was added to alcohol and coagulated while the pH was adjusted to 3 to 5 with a saturated sodium chloride aqueous solution or formic acid to give a crumb polymer. The polymer was dried with a vacuum dryer at 40° C. to obtain a solid rubber (emulsion-polymerized rubber).

Materials used in Production Examples 1 and 2 are as follows.
Emulsifier (1): rosin acid soap available from Harima Chemicals Group, Inc.
Emulsifier (2): fatty acid soap available from FUJIFILM Wako Pure Chemical Corporation
Electrolyte: sodium phosphate available from FUJIFILM Wako Pure Chemical Corporation
Styrene: styrene available from FUJIFILM Wako Pure Chemical Corporation
Methacrylic acid: methacrylic acid available from FUJIFILM Wako Pure Chemical Corporation
Butadiene: 1,3-butadiene available from Takachiho Chemical Industrial Co., Ltd.
Molecular weight regulator: tert-dodecylmercaptan available from FUJIFILM Wako Pure Chemical Corporation
Radical initiator: paramenthane hydroperoxide available from NOF Corporation
SFS: sodium formaldehyde sulfoxylate available from FUJIFILM Wako Pure Chemical Corporation
EDTA: sodium ethylenediaminetetraacetate available from FUJIFILM Wako Pure Chemical Corporation
Catalyst: ferric sulfate available from FUJIFILM Wako Pure Chemical Corporation
Polymerization terminator: N,N′-dimethyldithiocarbamate available from FUJIFILM Wako Pure Chemical Corporation
Alcohol: methanol, ethanol available from Kanto Chemical Co., Inc.
Formic acid: formic acid available from Kanto Chemical Co., Inc.
Sodium chloride: sodium chloride available from FUJIFILM Wako Pure Chemical Corporation

### <NMR Analysis>

The carboxylic acid group content of each modified rubber was calculated by ¹H-NMR analysis.

### EXAMPLES AND COMPARATIVE EXAMPLES

According to the formulations in the tables, the chemicals other than the sulfur and the vulcanization accelerators were kneaded in a 16-L Banbury mixer (Kobe Steel, Ltd.) at 160° C. for four minutes to obtain a kneaded mixture. Next, the kneaded mixture was kneaded with the sulfur and vulcanization accelerators using an open roll mill at 80° C. for four minutes to obtain an unvulcanized rubber composition. The obtained unvulcanized rubber composition was formed into the shape of a tread and assembled with other tire components on a tire building machine to build an unvulcanized tire. The unvulcanized tire was vulcanized at 170° C. for 12 minutes, whereby a test tire (size: 195/65R15, specification: shown in the tables) was produced.

The produced test tire was subjected to measurement of the physical properties and evaluation as described below. Tables show the results. The reference comparative examples are as follows.

Dry grip performance: Dry grip performance index of Comparative Example 1-1 in Table 1 and that of Comparative Example 2-1 in Table 2.

Wet grip performance: Wet grip performance index of Comparative Example 1-1 in Table 1 and that of Comparative Example 2-1 in Table 2.

Dry grip performance after driving on wet road surface: Dry grip performance index of Comparative Example 1-1 in Table 1 and that of Comparative Example 2-1 in Table 2.

### <Viscoelastic Test>

A viscoelastic measurement sample having a length of 40 mm, a width of 3 mm, and a thickness of 0.5 mm was collected from the inside of a tread rubber layer in each test tire such that the longitudinal direction of the sample corresponded to the circumferential direction of the tire. The tan δ and E* of the tread rubber were measured under the conditions of a temperature of 30° C., an initial strain of 10%, a dynamic strain of 1%, a frequency of 10 Hz, an elongation mode, and a measurement duration of 30 minutes using a RSA series machine available from TA Instruments. A measurement value was obtained after 30 minutes from the start of the measurement.

The thickness direction of the sample corresponds to the radial direction of the tire.

<E* and Tan δ when Dry>

The viscoelastic measurement sample having a length of 40 mm, a width of 3 mm, and a thickness of 0.5 mm was dried at room temperature and normal pressure to a constant weight. The complex modulus of elasticity E* and the loss tangent tan δ of the dried vulcanized rubber composition (rubber piece) were measured by the above-described method in the viscoelastic test. The measured E* and tan δ were determined as E* and tan δ when dry, respectively.

<E* and Tan δ when Wet with Water>

The viscoelasticity was measured in water by the above-described method in the viscoelastic test using an immersion measurement jig of the RSA to determine the E* and tan δ. The temperature of the water was 30° C.

### <40% Modulus at 70° C. Before Tensile Test>

A test piece was cut out from the inside of a tread rubber layer in each test tire such that the longitudinal direction corresponded to the tire circumferential direction. A tensile test was performed using the test piece (#7 dumbbell-shaped test piece) at 70° C. and a tensile rate of 200 mm/min in accordance with “Rubber, vulcanized or thermoplastic-Determination of tensile stress-strain properties” specified in JIS K 6251:2010 to measure the stress (MPa) at 40% elongation.

<40% Modulus at 70° C. after Tensile Test>

The sample after the above-described measurement of the stress at 40% elongation was subsequently extended to 50% elongation at 70° C., and then the stress was released. The stress-released test piece was directly subjected to a tensile test at 70° C. and a tensile rate of 200 mm/min, and the stress (MPa) at 40% elongation was measured.

### <Dry Grip Performance>

The test tire was mounted on every wheel of a front-engine, front-wheel-drive car of 2000 cc displacement made in Japan. Twenty test drivers confirmed the specification and subjectively evaluated the dry grip performance during driving in a test course with a dry road surface on a five-point scale. The sum of the evaluation points was determined as an evaluation score and expressed as an index relative to the score in the reference comparative example taken as 100. A higher index indicates better dry grip performance.

### <Wet Grip Performance>

After the evaluation of the dry grip performance, twenty drivers subjectively evaluated the wet grip performance during driving in a test course with a wet road surface on a five-point scale. The sum of the evaluation points was determined as an evaluation score and expressed as an index relative to the score in the reference comparative example taken as 100. A higher index indicates better wet grip performance.

<Dry Grip Performance after Driving on Wet Road Surface>

After the evaluation of the wet grip performance, twenty drivers again subjectively evaluated the dry grip performance during driving in a test course with a dry road surface on a five-point scale. The sum of the evaluation points was determined as an evaluation score and expressed as an index relative to the score in the reference comparative example (the reference comparative example for the dry grip performance) taken as 100. A higher index indicates better dry grip performance after driving on a wet road surface.

### <Overall Performance>

Suppression of changes in performances caused by changes in road conditions from dry to wet road surface or from wet to dry road surface was evaluated from the sum of three indices obtained in the evaluation of the dry grip performance, the evaluation of the wet grip performance, and the evaluation of the dry grip performance after driving on wet road surface. A higher value indicates better suppression of changes in performances.

TABLE 1

| | | Example | | | | | | | | | |
|---|---|---|---|---|---|---|---|---|---|---|---|
| | | 1-1 | 1-2 | 1-3 | 1-4 | 1-5 | 1-6 | 1-7 | 1-8 | 1-9 | 1-10 |
| Amount | Carboxylic acid- | 50 | 50 | 50 | 50 | 50 | 50 | 50 | 50 | 50 | 50 |
| (parts | modified SBR | | | | | | | | | | |
| by mass) | Carboxylic acid- | | | | | | | | | | |
| | modified BR | | | | | | | | | | |
| | NR | 10 | 10 | 10 | 10 | 10 | 10 | 10 | 10 | 10 | 10 |
| | SBR | 20 | 20 | 20 | 20 | 20 | 20 | 20 | 20 | 20 | 20 |
| | BR | 20 | 20 | 20 | 20 | 20 | 20 | 20 | 20 | 20 | 20 |
| | Carbon black | 10 | 10 | 10 | 10 | 10 | 10 | 10 | 10 | 10 | 10 |
| | Silica 1 (VN3) | 65 | 65 | 65 | 65 | 65 | 65 | 65 | 65 | | |
| | Silica 2 (9100Gr) | | | | | | | | | 65 | 65 |
| | Stearic acid | 2 | 2 | 2 | 2 | 2 | 2 | 2 | 2 | 2 | 2 |
| | Potassium acetate | 7.24 | 7.24 | 7.24 | 7.24 | | | 7.24 | 7.24 | 7.24 | 7.24 |
| | Calcium acetate | | | | | 11.66 | 11.66 | | | | |
| | Zinc oxide | | | | | | | | | | |
| | Oil | 10 | 10 | 10 | 10 | 10 | 10 | 10 | 10 | 10 | 10 |
| | Silane coupling | 5.2 | 5.2 | 5.2 | 5.2 | 5.2 | 5.2 | | | 5.2 | 5.2 |
| | agent 1 (Si69) | | | | | | | | | | |
| | Silane coupling | | | | | | | 5.2 | 5.2 | | |
| | agent 2 (NXT-Z45) | | | | | | | | | | |
| | Resin | | 10 | 10 | 10 | 10 | 10 | 10 | 10 | 10 | 10 |
| | Antioxidant | 2.8 | 2.8 | 2.8 | 2.8 | 2.8 | 2.8 | 2.8 | 2.8 | 2.8 | 2.8 |
| | Sulfur | 2.0 | 2.0 | 2.0 | 2.5 | 2.0 | 2.5 | 1.0 | 2.0 | 2.0 | 2.0 |
| | Vulcanization | 2.3 | 2.3 | 2.3 | 2.3 | 2.3 | 2.3 | 2.3 | 2.3 | 2.3 | 2.3 |
| | accelerator DPG | | | | | | | | | | |
| | Vulcanization | 1.6 | 1.6 | 1.6 | 1.6 | 1.6 | 1.6 | 1.6 | 1.6 | 1.6 | 1.6 |
| | accelerator NS | | | | | | | | | | |
| Physical | E* (MPa) when | 8.1 | 7.1 | 7.1 | 7.6 | 7.4 | 7.9 | 7.4 | 8.0 | 8.3 | 8.3 |
| properties/ | wet with water | | | | | | | | | | |
| Evaluation | E* (MPa) when dry | 9.6 | 8.3 | 8.3 | 8.9 | 8.6 | 9.0 | 8.7 | 9.4 | 9.9 | 9.9 |
| | E* when wet with | 0.85 | 0.85 | 0.85 | 0.86 | 0.86 | 0.88 | 0.85 | 0.85 | 0.84 | 0.84 |
| | water/E* when dry | | | | | | | | | | |
| | tan δ when wet | 0.27 | 0.30 | 0.30 | 0.27 | 0.28 | 0.25 | 0.31 | 0.28 | 0.32 | 0.32 |
| | with water | | | | | | | | | | |
| | tan δ when dry | 0.23 | 0.26 | 0.26 | 0.24 | 0.24 | 0.22 | 0.27 | 0.24 | 0.28 | 0.28 |
| | tan δ when wet with | 1.16 | 1.16 | 1.16 | 1.14 | 1.15 | 1.13 | 1.16 | 1.15 | 1.16 | 1.16 |
| | water/tan δ when dry | | | | | | | | | | |
| | 40% modulus (MPa) | 0.50 | 0.47 | 0.47 | 0.53 | 0.51 | 0.57 | 0.45 | 0.57 | 0.56 | 0.56 |
| | after tensile test | | | | | | | | | | |
| | at 70° C. | | | | | | | | | | |
| | 40% modulus (MPa) | 0.95 | 0.90 | 0.90 | 0.97 | 0.94 | 1.02 | 0.87 | 0.98 | 1.05 | 1.05 |
| | before tensile test | | | | | | | | | | |
| | at 70° C. | | | | | | | | | | |
| | 40% modulus after | 0.53 | 0.52 | 0.52 | 0.55 | 0.54 | 0.56 | 0.52 | 0.58 | 0.53 | 0.53 |
| | tensile test at 70° C./ | | | | | | | | | | |
| | 40% modulus before | | | | | | | | | | |
| | tensile test at 70° C. | | | | | | | | | | |
| | Thickness G (mm) | 10.0 | 10.0 | 8.0 | 8.0 | 8.0 | 8.0 | 8.0 | 8.0 | 8.0 | 8.0 |
| | Groove depth D (mm) | 8.0 | 8.0 | 6.0 | 6.0 | 6.0 | 6.0 | 6.0 | 6.0 | 6.0 | 6.0 |
| | Negative ratio S (%) | 30.0 | 30.0 | 30.0 | 30.0 | 30.0 | 30.0 | 30.0 | 30.0 | 30.0 | 25.0 |
| | [(40% modulus after | 5.3 | 5.2 | 6.5 | 6.9 | 6.8 | 7.0 | 6.5 | 7.3 | 6.6 | 6.6 |
| | tensile test at 70° C./ | | | | | | | | | | |
| | 40% modulus before | | | | | | | | | | |
| | tensile test at 70° | | | | | | | | | | |
| | C.)/G] × 100 | | | | | | | | | | |
| | [(40% modulus after | 6.6 | 6.5 | 8.7 | 9.2 | 9.0 | 9.3 | 8.7 | 9.7 | 8.8 | 8.8 |
| | tensile test at 70° C./ | | | | | | | | | | |
| | 40% modulus before | | | | | | | | | | |
| | tensile test at 70° | | | | | | | | | | |
| | C.)/D] × 100 | | | | | | | | | | |
| | [(40% modulus after | 1.8 | 1.7 | 1.7 | 1.8 | 1.8 | 1.9 | 1.7 | 1.9 | 1.8 | 2.1 |
| | tensile test at 70° C./ | | | | | | | | | | |
| | 40% modulus before | | | | | | | | | | |
| | tensile test at 70° | | | | | | | | | | |
| | C.)/S] × 100 | | | | | | | | | | |
| | (a) Dry grip performance | 102 | 102 | 104 | 104 | 102 | 104 | 102 | 104 | 104 | 106 |
| | (b) Wet grip performance | 106 | 108 | 110 | 108 | 106 | 106 | 108 | 108 | 110 | 114 |
| | (c) Dry grip performance | 98 | 98 | 100 | 102 | 100 | 102 | 100 | 106 | 102 | 106 |
| | after driving on wet | | | | | | | | | | |
| | road surface | | | | | | | | | | |
| | Overall performance | 306 | 308 | 314 | 314 | 308 | 312 | 310 | 318 | 316 | 326 |
| | (=(a) + (b) + (c)) | | | | | | | | | | |

| | | Example | | | | Comparative Example | | | | |
|---|---|---|---|---|---|---|---|---|---|---|
| | | 1-11 | 1-12 | 1-13 | 1-14 | 1-1 | 1-2 | 1-3 | 1-4 | 1-5 |
| Amount | Carboxylic acid- | 50 | 50 | 50 | 50 | | 50 | 50 | | |
| (parts | modified SBR | | | | | | | | | |
| by mass) | Carboxylic acid- | | | | | | | | | |
| | modified BR | | | | | | | | | |
| | NR | 10 | 10 | 10 | 10 | 10 | 10 | 10 | 10 | 10 |
| | SBR | 20 | 20 | 20 | 20 | 70 | 20 | 20 | 70 | 70 |
| | BR | 20 | 20 | 20 | 20 | 20 | 20 | 20 | 20 | 20 |
| | Carbon black | 10 | 10 | 10 | 10 | 10 | 10 | 10 | 10 | 10 |
| | Silica 1 (VN3) | 65 | 65 | 65 | 65 | 65 | 65 | 65 | 65 | 65 |
| | Silica 2 (9100Gr) | | | | | | | | | |
| | Stearic acid | 2 | 2 | 2 | 2 | 2 | 2 | 2 | 2 | 2 |
| | Potassium acetate | 7.24 | 7.24 | 7.24 | 7.24 | | 7.24 | | | |
| | Calcium acetate | | | | | | | 11.66 | | |
| | Zinc oxide | | | | | 2.2 | | | 2.2 | 2.2 |
| | Oil | 10 | 10 | 10 | 10 | | | | 10 | |
| | Silane coupling | 5.2 | 5.2 | | | 5.2 | 5.2 | 5.2 | 5.2 | 5.2 |
| | agent 1 (Si69) | | | | | | | | | |
| | Silane coupling | | | 7.8 | 10.4 | | | | | |
| | agent 2 (NXT-Z45) | | | | | | | | | |
| | Resin | 10 | 10 | 10 | 10 | | | | | |
| | Antioxidant | 2.8 | 2.8 | 2.8 | 2.8 | 2.8 | 2.8 | 2.8 | 2.8 | 2.8 |
| | Sulfur | 2.8 | 3.0 | 2.0 | 2.0 | 1.0 | 1.0 | 1.0 | 1.0 | 1.0 |
| | Vulcanization | 2.3 | 2.3 | 2.3 | 2.3 | 2.3 | 2.3 | 2.3 | 2.3 | 2.3 |
| | accelerator DPG | | | | | | | | | |
| | Vulcanization | 1.6 | 1.6 | 1.6 | 1.6 | 1.6 | 1.6 | 1.6 | 1.6 | 1.6 |
| | accelerator NS | | | | | | | | | |
| Physical | E* (MPa) when | 7.9 | 8.4 | 8.3 | 8.6 | 6.0 | 7.4 | 7.8 | 5.2 | 6.0 |
| properties/ | wet with water | | | | | | | | | |
| Evaluation | E* (MPa) when dry | 8.9 | 9.4 | 9.7 | 9.9 | 6.1 | 8.7 | 9.1 | 5.3 | 6.2 |
| | E* when wet with | 0.89 | 0.90 | 0.86 | 0.87 | 0.98 | 0.85 | 0.86 | 0.99 | 0.98 |
| | water/E* when dry | | | | | | | | | |
| | tan δ when wet | 0.26 | 0.25 | 0.31 | 0.33 | 0.20 | 0.32 | 0.29 | 0.22 | 0.20 |
| | with water | | | | | | | | | |
| | tan δ when dry | 0.23 | 0.22 | 0.27 | 0.29 | 0.20 | 0.27 | 0.25 | 0.22 | 0.20 |
| | tan δ when wet with | 1.15 | 1.14 | 1.15 | 1.13 | 1.00 | 1.17 | 1.17 | 1.00 | 1.00 |
| | water/tan δ when dry | | | | | | | | | |
| | 40% modulus (MPa) | 0.57 | 0.63 | 0.62 | 0.65 | 0.62 | 0.35 | 0.38 | 0.56 | 0.62 |
| | after tensile test | | | | | | | | | |
| | at 70° C. | | | | | | | | | |
| | 40% modulus (MPa) | 1.00 | 1.05 | 1.03 | 1.07 | 1.26 | 0.88 | 0.91 | 1.15 | 1.26 |
| | before tensile test | | | | | | | | | |
| | at 70° C. | | | | | | | | | |
| | 40% modulus after | 0.57 | 0.60 | 0.60 | 0.61 | 0.49 | 0.40 | 0.42 | 0.49 | 0.49 |
| | tensile test at 70° C./ | | | | | | | | | |
| | 40% modulus before | | | | | | | | | |
| | tensile test at 70° C. | | | | | | | | | |
| | Thickness G (mm) | 8.0 | 8.0 | 8.0 | 8.0 | 10.0 | 10.0 | 10.0 | 10.0 | 8.0 |
| | Groove depth D (mm) | 6.0 | 6.0 | 6.0 | 6.0 | 8.0 | 8.0 | 8.0 | 8.0 | 6.0 |
| | Negative ratio S (%) | 30.0 | 30.0 | 30.0 | 30.0 | 30.0 | 30.0 | 30.0 | 30.0 | 30.0 |
| | [(40% modulus after | 7.1 | 7.5 | 7.5 | 7.6 | 4.9 | 4.0 | 4.2 | 4.9 | 6.1 |
| | tensile test at 70° C./ | | | | | | | | | |
| | 40% modulus before | | | | | | | | | |
| | tensile test at 70° | | | | | | | | | |
| | C.)/G] × 100 | | | | | | | | | |
| | [(40% modulus after | 9.5 | 10.0 | 10.0 | 10.2 | 6.1 | 5.0 | 5.3 | 6.1 | 8.2 |
| | tensile test at 70° C./ | | | | | | | | | |
| | 40% modulus before | | | | | | | | | |
| | tensile test at 70° | | | | | | | | | |
| | C.)/D] × 100 | | | | | | | | | |
| | [(40% modulus after | 1.9 | 2.0 | 2.0 | 2.0 | 1.6 | 1.3 | 1.4 | 1.6 | 1.6 |
| | tensile test at 70° C./ | | | | | | | | | |
| | 40% modulus before | | | | | | | | | |
| | tensile test at 70° | | | | | | | | | |
| | C.)/S] × 100 | | | | | | | | | |
| | (a) Dry grip performance | 105 | 106 | 105 | 105 | 100 | 100 | 98 | 100 | 100 |
| | (b) Wet grip performance | 107 | 106 | 107 | 106 | 100 | 106 | 106 | 102 | 100 |
| | (c) Dry grip performance | 104 | 105 | 105 | 105 | 98 | 90 | 90 | 98 | 98 |
| | after driving on wet | | | | | | | | | |
| | road surface | | | | | | | | | |
| | Overall performance | 316 | 317 | 317 | 316 | 298 | 296 | 294 | 300 | 298 |
| | (=(a) + (b) + (c)) | | | | | | | | | |

TABLE 2

| | | Example | | | | | | | | | |
|---|---|---|---|---|---|---|---|---|---|---|---|
| | | 2-1 | 2-2 | 2-3 | 2-4 | 2-5 | 2-6 | 2-7 | 2-8 | 2-9 | 2-10 |
| Amount | Carboxylic acid- | | | | | | | | | | |
| (parts | modified SBR | | | | | | | | | | |
| by mass) | Carboxylic acid- | 50 | 50 | 50 | 50 | 50 | 50 | 50 | 50 | 50 | 50 |
| | modified BR | | | | | | | | | | |
| | NR | 10 | 10 | 10 | 10 | 10 | 10 | 10 | 10 | 10 | 10 |
| | SBR | 20 | 20 | 20 | 20 | 20 | 20 | 20 | 20 | 20 | 20 |
| | BR | 20 | 20 | 20 | 20 | 20 | 20 | 20 | 20 | 20 | 20 |
| | Carbon black | 10 | 10 | 10 | 10 | 10 | 10 | 10 | 10 | 10 | 10 |
| | Silica 1 (VN3) | 65 | 65 | 65 | 65 | 65 | 65 | 65 | 65 | | |
| | Silica 2 (9100Gr) | | | | | | | | | 65 | 65 |
| | Stearic acid | 2 | 2 | 2 | 2 | 2 | 2 | 2 | 2 | 2 | 2 |
| | Potassium acetate | 7.24 | 7.24 | 7.24 | 7.24 | | | 7.24 | 7.24 | 7.24 | 7.24 |
| | Calcium acetate | | | | | 11.66 | 11.66 | | | | |
| | Zinc oxide | | | | | | | | | | |
| | Oil | 10 | 10 | 10 | 10 | 10 | 10 | 10 | 10 | 10 | 10 |
| | Silane coupling | 5.2 | 5.2 | 5.2 | 5.2 | 5.2 | 5.2 | | | 5.2 | 5.2 |
| | agent 1 (Si69) | | | | | | | | | | |
| | Silane coupling | | | | | | | 5.2 | 5.2 | | |
| | agent 2 (NXT-Z45) | | | | | | | | | | |
| | Resin | | 10 | 10 | 10 | 10 | 10 | 10 | 10 | 10 | 10 |
| | Antioxidant | 2.8 | 2.8 | 2.8 | 2.8 | 2.8 | 2.8 | 2.8 | 2.8 | 2.8 | 2.8 |
| | Sulfur | 2.0 | 2.0 | 2.0 | 2.5 | 2.0 | 2.5 | 1.0 | 2.0 | 2.0 | 2.0 |
| | Vulcanization | 2.3 | 2.3 | 2.3 | 2.3 | 2.3 | 2.3 | 2.3 | 2.3 | 2.3 | 2.3 |
| | accelerator DPG | | | | | | | | | | |
| | Vulcanization | 1.6 | 1.6 | 1.6 | 1.6 | 1.6 | 1.6 | 1.6 | 1.6 | 1.6 | 1.6 |
| | accelerator NS | | | | | | | | | | |
| Physical | E* (MPa) when | 7.92 | 7.06 | 7.06 | 7.71 | 7.66 | 8.40 | 7.08 | 7.82 | 8.59 | 8.59 |
| properties/ | wet with water | | | | | | | | | | |
| Evaluation | E* (MPa) when dry | 9.10 | 8.12 | 8.12 | 8.76 | 8.70 | 9.44 | 8.23 | 8.99 | 9.76 | 9.76 |
| | E* when wet with | 0.87 | 0.87 | 0.87 | 0.88 | 0.88 | 0.89 | 0.86 | 0.87 | 0.88 | 0.88 |
| | water/E* when dry | | | | | | | | | | |
| | tan δ when wet | 0.25 | 0.28 | 0.28 | 0.27 | 0.26 | 0.23 | 0.31 | 0.29 | 0.32 | 0.32 |
| | with water | | | | | | | | | | |
| | tan δ when dry | 0.22 | 0.25 | 0.25 | 0.24 | 0.23 | 0.21 | 0.27 | 0.26 | 0.28 | 0.28 |
| | tan δ when wet with | 1.13 | 1.13 | 1.13 | 1.13 | 1.13 | 1.11 | 1.14 | 1.13 | 1.15 | 1.15 |
| | water/tan δ when dry | | | | | | | | | | |
| | 40% modulus (MPa) | 0.49 | 0.46 | 0.46 | 0.51 | 0.50 | 0.55 | 0.43 | 0.51 | 0.54 | 0.54 |
| | after tensile test | | | | | | | | | | |
| | at 70° C. | | | | | | | | | | |
| | 40% modulus (MPa) | 0.91 | 0.86 | 0.86 | 0.90 | 0.89 | 0.95 | 0.80 | 0.89 | 1.00 | 1.00 |
| | before tensile test | | | | | | | | | | |
| | at 70° C. | | | | | | | | | | |
| | 40% modulus after | 0.54 | 0.54 | 0.54 | 0.57 | 0.56 | 0.58 | 0.54 | 0.57 | 0.54 | 0.54 |
| | tensile test at 70° C./ | | | | | | | | | | |
| | 40% modulus before | | | | | | | | | | |
| | tensile test at 70° C. | | | | | | | | | | |
| | Thickness G (mm) | 10.0 | 10.0 | 8.0 | 8.0 | 8.0 | 8.0 | 8.0 | 8.0 | 8.0 | 8.0 |
| | Groove depth D (mm) | 8.0 | 8.0 | 6.0 | 6.0 | 6.0 | 6.0 | 6.0 | 6.0 | 6.0 | 6.0 |
| | Negative ratio S (%) | 30.0 | 30.0 | 30.0 | 30.0 | 30.0 | 30.0 | 30.0 | 30.0 | 30.0 | 25.0 |
| | [(40% modulus after | 5.4 | 5.4 | 6.8 | 7.1 | 7.0 | 7.3 | 6.8 | 7.1 | 6.8 | 6.8 |
| | tensile test at 70° C./ | | | | | | | | | | |
| | 40% modulus before | | | | | | | | | | |
| | tensile test at 70° | | | | | | | | | | |
| | C.)/G] × 100 | | | | | | | | | | |
| | [(40% modulus after | 6.8 | 6.8 | 9.0 | 9.5 | 9.3 | 9.7 | 9.0 | 9.5 | 9.0 | 9.0 |
| | tensile test at 70° C./ | | | | | | | | | | |
| | 40% modulus before | | | | | | | | | | |
| | tensile test at 70° | | | | | | | | | | |
| | C.)/D] × 100 | | | | | | | | | | |
| | [(40% modulus after | 1.8 | 1.8 | 1.8 | 1.9 | 1.9 | 1.9 | 1.8 | 1.9 | 1.8 | 2.2 |
| | tensile test at 70° C./ | | | | | | | | | | |
| | 40% modulus before | | | | | | | | | | |
| | tensile test at 70° | | | | | | | | | | |
| | C.)/S] × 100 | | | | | | | | | | |
| | (a) Dry grip performance | 102 | 102 | 104 | 102 | 102 | 104 | 102 | 102 | 104 | 106 |
| | (b) Wet grip performance | 104 | 108 | 110 | 108 | 108 | 106 | 110 | 108 | 110 | 114 |
| | (c) Dry grip performance | 98 | 98 | 100 | 102 | 100 | 102 | 100 | 102 | 102 | 106 |
| | after driving on wet | | | | | | | | | | |
| | road surface | | | | | | | | | | |
| | Overall performance | 304 | 308 | 314 | 312 | 310 | 312 | 312 | 312 | 316 | 326 |
| | (=(a) + (b) + (c)) | | | | | | | | | | |

| | | Example | | | | Comparative Example | | | | |
|---|---|---|---|---|---|---|---|---|---|---|
| | | 2-11 | 2-12 | 2-13 | 2-14 | 2-1 | 2-2 | 2-3 | 2-4 | 2-5 |
| Amount | Carboxylic acid- | | | | | | | | | |
| (parts | modified SBR | | | | | | | | | |
| by mass) | Carboxylic acid- | 50 | 50 | 50 | 50 | | 50 | 50 | | |
| | modified BR | | | | | | | | | |
| | NR | 10 | 10 | 10 | 10 | 10 | 10 | 10 | 10 | 10 |
| | SBR | 20 | 20 | 20 | 20 | 20 | 20 | 20 | 20 | 20 |
| | BR | 20 | 20 | 20 | 20 | 70 | 20 | 20 | 70 | 70 |
| | Carbon black | 10 | 10 | 10 | 10 | 10 | 10 | 10 | 10 | 10 |
| | Silica 1 (VN3) | 65 | 65 | 65 | 65 | 65 | 65 | 65 | 65 | 65 |
| | Silica 2 (9100Gr) | | | | | | | | | |
| | Stearic acid | 2 | 2 | 2 | 2 | 2 | 2 | 2 | 2 | 2 |
| | Potassium acetate | 7.24 | 7.24 | 7.24 | 7.24 | | 7.24 | | | |
| | Calcium acetate | | | | | | | 11.66 | | |
| | Zinc oxide | | | | | 2.2 | | | 2.2 | 2.2 |
| | Oil | 10 | 10 | 10 | 10 | 10 | 10 | 10 | 10 | |
| | Silane coupling | 5.2 | 5.2 | | | 5.2 | 5.2 | 5.2 | 5.2 | 5.2 |
| | agent 1 (Si69) | | | | | | | | | |
| | Silane coupling | | | 7.8 | 10.4 | | | | | |
| | agent 2 (NXT-Z45) | | | | | | | | | |
| | Resin | 10 | 10 | 10 | 10 | | | | 10 | |
| | Antioxidant | 2.8 | 2.8 | 2.8 | 2.8 | 2.8 | 2.8 | 2.8 | 2.8 | 2.8 |
| | Sulfur | 2.8 | 3.0 | 2.0 | 2.0 | 1.0 | 1.0 | 1.0 | 1.0 | 1.0 |
| | Vulcanization | 2.3 | 2.3 | 2.3 | 2.3 | 2.3 | 2.3 | 2.3 | 2.3 | 2.3 |
| | accelerator DPG | | | | | | | | | |
| | Vulcanization | 1.6 | 1.6 | 1.6 | 1.6 | 1.6 | 1.6 | 1.6 | 1.6 | 1.6 |
| | accelerator NS | | | | | | | | | |
| Physical | E* (MPa) when | 7.89 | 8.13 | 8.06 | 8.49 | 4.95 | 7.11 | 7.52 | 4.26 | 5.87 |
| properties/ | wet with water | | | | | | | | | |
| Evaluation | E* (MPa) when dry | 8.87 | 9.03 | 9.26 | 9.54 | 4.95 | 8.17 | 8.54 | 4.30 | 5.87 |
| | E* when wet with | 0.89 | 0.90 | 0.87 | 0.89 | 1.00 | 0.87 | 0.88 | 0.99 | 1.00 |
| | water/E* when dry | | | | | | | | | |
| | tan δ when wet | 0.25 | 0.22 | 0.33 | 0.36 | 0.18 | 0.26 | 0.26 | 0.20 | 0.17 |
| | with water | | | | | | | | | |
| | tan δ when dry | 0.22 | 0.19 | 0.29 | 0.32 | 0.18 | 0.23 | 0.23 | 0.20 | 0.17 |
| | tan δ when wet with | 1.14 | 1.14 | 1.14 | 1.12 | 1.00 | 1.13 | 1.13 | 1.00 | 1.00 |
| | water/tan δ when dry | | | | | | | | | |
| | 40% modulus (MPa) | 0.56 | 0.60 | 0.58 | 0.63 | 0.59 | 0.33 | 0.37 | 0.55 | 0.59 |
| | after tensile test | | | | | | | | | |
| | at 70° C. | | | | | | | | | |
| | 40% modulus (MPa) | 0.96 | 0.99 | 0.93 | 0.98 | 1.18 | 0.81 | 0.87 | 1.07 | 1.18 |
| | before tensile test | | | | | | | | | |
| | at 70° C. | | | | | | | | | |
| | 40% modulus after | 0.58 | 0.61 | 0.62 | 0.64 | 0.50 | 0.41 | 0.42 | 0.51 | 0.50 |
| | tensile test at 70° C./ | | | | | | | | | |
| | 40% modulus before | | | | | | | | | |
| | tensile test at 70° C. | | | | | | | | | |
| | Thickness G (mm) | 8.0 | 8.0 | 8.0 | 8.0 | 10.0 | 10.0 | 10.0 | 10.0 | 8.0 |
| | Groove depth D (mm) | 6.0 | 6.0 | 6.0 | 6.0 | 8.0 | 8.0 | 8.0 | 8.0 | 6.0 |
| | Negative ratio S (%) | 30.0 | 30.0 | 30.0 | 30.0 | 30.0 | 30.0 | 30.0 | 30.0 | 30.0 |
| | [(40% modulus after | 7.3 | 7.6 | 7.8 | 8.0 | 5.0 | 4.1 | 4.2 | 5.1 | 6.3 |
| | tensile test at 70° C./ | | | | | | | | | |
| | 40% modulus before | | | | | | | | | |
| | tensile test at 70° | | | | | | | | | |
| | C.)/G] × 100 | | | | | | | | | |
| | [(40% modulus after | 9.7 | 10.2 | 10.3 | 10.7 | 6.3 | 5.1 | 5.3 | 6.4 | 8.3 |
| | tensile test at 70° C./ | | | | | | | | | |
| | 40% modulus before | | | | | | | | | |
| | tensile test at 70° | | | | | | | | | |
| | C.)/D] × 100 | | | | | | | | | |
| | [(40% modulus after | 1.9 | 2.0 | 2.1 | 2.1 | 1.7 | 1.4 | 1.4 | 1.7 | 1.7 |
| | tensile test at 70° C./ | | | | | | | | | |
| | 40% modulus before | | | | | | | | | |
| | tensile test at 70° | | | | | | | | | |
| | C.)/S] × 100 | | | | | | | | | |
| | (a) Dry grip performance | 103 | 104 | 104 | 105 | 100 | 100 | 98 | 100 | 100 |
| | (b) Wet grip performance | 107 | 106 | 107 | 106 | 100 | 104 | 106 | 102 | 100 |
| | (c) Dry grip performance | 103 | 103 | 103 | 105 | 98 | 90 | 88 | 98 | 96 |
| | after driving on wet | | | | | | | | | |
| | road surface | | | | | | | | | |
| | Overall performance | 313 | 313 | 314 | 316 | 298 | 294 | 292 | 300 | 296 |
| | (=(a) + (b) + (c)) | | | | | | | | | |

The tires in the examples satisfying the formula (1) to (3) obtained good dry grip performance, good wet grip performance after driving on a dry road surface, and good dry grip performance after driving on a wet road surface even in the case where the road conditions changed from dry to wet road surface or from wet to dry road surface. The tires had excellent overall performance of these performances (expressed as a sum of the three indices of dry grip performance, wet grip performance, and dry grip performance after driving on a wet road surface). The results demonstrate that the tires can sufficiently suppress changes in performances caused by changes in road conditions from dry to wet road surface or from wet to dry road surface.

The present disclosure (1) relates to a rubber composition, having E* when wet with water (MPa), E* when dry (MPa), tan δ when wet with water, tan δ when dry, 40% modulus (MPa) at 70° C. before a tensile test, and 40% modulus (MPa) at 70° C. after the tensile test which satisfy the following formulas (1) to (3):
(1) E* when wet with water/E* when dry ≤0.90
(2) tan δ when wet with water/tan δ when dry >1.00
(3) 40% modulus at 70° C. after tensile test/40% modulus at 70° C. before tensile test ≥0.45
where
   E* and tan δ refer to a complex modulus of elasticity and a loss tangent, respectively, after 30 minutes from the start of measurement under the conditions of a temperature of 30° C., an initial strain of 10%, a dynamic strain of 1%, a frequency of 10 Hz, an elongation mode, and a measurement duration of 30 minutes;
   40% modulus at 70° C. after the tensile test refers to a tensile stress at an elongation of 40% determined after extension of 50% at 70° C., releasing the stress, and then measuring the tensile stress at an elongation of 40% at 70° C. in accordance with JIS K 6251:2010; and
   40% modulus at 70° C. before a tensile test refers to a tensile stress at an elongation of 40% measured before the tensile test at 70° C. in accordance with JIS K 6251:2010.

The present disclosure (2) is the rubber composition according to the present disclosure (1), further containing silica having an average primary particle size of 18 nm or less.

The present disclosure (3) is the rubber composition according to the present disclosure (1) or (2), further containing resin.

The present disclosure (4) is the rubber composition according to any one of the present disclosures (1) to (3), further containing sulfur in an amount of 2.0 parts by mass or more per 100 parts by mass of a rubber component therein.

The present disclosure (5) is the rubber composition according to any one of the present disclosures (1) to (4), further containing a mercapto silane coupling agent.

The present disclosure (6) is the rubber composition according to any one of the present disclosures (1) to (5), further containing
a modified rubber containing at least one selected from the group consisting of carboxylic acid, sulfonic acid, and salts thereof in its molecule, and
an alkali metal salt or an alkaline earth metal salt.

The present disclosure (7) relates to a tire including a tread including the rubber composition according to any one of the present disclosures (1) to (6).

The present disclosure (8) is the tire according to the present disclosure (7),
wherein the tread has a thickness G of 9.0 mm or less on the equator in a radial cross-section of the tire.

The present disclosure (9) is the tire according to the present disclosure (7) or (8),
wherein the 40% modulus (MPa) at 70° C. before a tensile test and the 40% modulus (MPa) at 70° C. after the tensile test of the rubber composition and the thickness G (mm) of the tread on the equator in a radial cross-section of the tire satisfy the following formula:

[(40% modulus at 70° C. after tensile test/40% modulus at 70° C. before tensile test)/G]×100≥5.3
where
40% modulus at 70° C. after the tensile test refers to a tensile stress at an elongation of 40% determined after extension of 50% at 70° C., releasing the stress, and then measuring the tensile stress at an elongation of 40% at 70° C. in accordance with JIS K 6251:2010; and
40% modulus at 70° C. before a tensile test refers to a tensile stress at an elongation of 40% measured before the tensile test at 70° C. in accordance with JIS K 6251:2010.

The present disclosure (10) is the tire according to any one of the present disclosures (7) to (9),
wherein the 40% modulus (MPa) at 70° C. before a tensile test and the 40% modulus (MPa) at 70° C. after the tensile test of the rubber composition and a groove depth D (mm) of a circumferential groove on the tread satisfy the following formula:

[(40% modulus at 70° C. after tensile test/40% modulus at 70° C. before tensile test)/D]×100≥8.0

where
40% modulus at 70° C. after the tensile test refers to a tensile stress at an elongation of 40% determined after extension of 50% at 70° C., releasing the stress, and then measuring the tensile stress at an elongation of 40% at 70° C. in accordance with JIS K 6251:2010; and
40% modulus at 70° C. before a tensile test refers to a tensile stress at an elongation of 40% measured before the tensile test at 70° C. in accordance with JIS K 6251:2010.

The present disclosure (11) is the tire according to any one of the present disclosures (7) to (10),
wherein the 40% modulus (MPa) at 70° C. before a tensile test and the 40% modulus (MPa) at 70° C. after the tensile test of the rubber composition and a negative ratio S (%) of the tread satisfy the following formula:

[(40% modulus at 70° C. after tensile test/40% modulus at 70° C. before tensile test)/S]×100≥2.0

where
40% modulus at 70° C. after the tensile test refers to a tensile stress at an elongation of 40% determined after extension of 50% at 70° C., releasing the stress, and then measuring the tensile stress at an elongation of 40% at 70° C. in accordance with JIS K 6251:2010; and
40% modulus at 70° C. before a tensile test refers to a tensile stress at an elongation of 40% measured before the tensile test at 70° C. in accordance with JIS K 6251:2010.

### REFERENCE SIGNS LIST

1 tire
2 tread
3 sidewall
4 bead
5 carcass
6 belt
7 tread face
8 groove
10 core
11 apex
12 carcass ply
13 inner layer belt
14 outer layer belt
15 shoulder portion
17 crown center (tread center line CL, equator EQ of tire
1)
20 step
D groove depth of circumferential groove
G thickness of tread portion on the equator in radial cross-section of tire

1. A rubber composition, having E* when wet with water (MPa), E* when dry (MPa), tan δ when wet with water, tan δ when dry, 40% modulus (MPa) at 70° C. before a tensile test, and 40% modulus (MPa) at 70° C. after the tensile test which satisfy the following formulas (1) to (3):
(1) E* when wet with water/E* when dry ≤0.90
(2) tan δ when wet with water/tan δ when dry >1.00
(3) 40% modulus at 70° C. after tensile test/40% modulus at 70° C. before tensile test ≥0.45 where
E* and tan δ refer to a complex modulus of elasticity and a loss tangent, respectively, after 30 minutes from the start of measurement under the conditions of a temperature of 30° C., an initial strain of 10%, a dynamic strain of 1%, a frequency of 10 Hz, an elongation mode, and a measurement duration of 30 minutes;
40% modulus at 70° C. after the tensile test refers to a tensile stress at an elongation of 40% determined after extension of 50% at 70° C., releasing the stress, and then measuring the tensile stress at an elongation of 40% at 70° C. in accordance with JIS K 6251:2010; and
40% modulus at 70° C. before a tensile test refers to a tensile stress at an elongation of 40% measured before the tensile test at 70° C. in accordance with JIS K 6251:2010.

2. The rubber composition according to claim 1, further comprising silica having an average primary particle size of 18 nm or less.

3. The rubber composition according to claim 1, further comprising resin.

4. The rubber composition according to claim 1, further comprising sulfur in an amount of 2.0 parts by mass or more per 100 parts by mass of a rubber component therein.

5. The rubber composition according to claim 1, further comprising a mercapto silane coupling agent.

6. The rubber composition according to claim 1, further comprising
a modified rubber containing at least one selected from the group consisting of carboxylic acid, sulfonic acid, and salts thereof in its molecule, and
an alkali metal salt or an alkaline earth metal salt.

7. A tire comprising a tread including the rubber composition according to claim 1.

8. The tire according to claim 7,
wherein the tread has a thickness G of 9.0 mm or less on the equator in a radial cross-section of the tire.

9. The tire according to claim 7,
wherein the 40% modulus (MPa) at 70° C. before a tensile test and the 40% modulus (MPa) at 70° C. after the tensile test of the rubber composition and the thickness G (mm) of the tread on the equator in a radial cross-section of the tire satisfy the following formula:
[(40% modulus at 70° C. after tensile test/40% modulus at 70° C. before tensile test)/G]×100≥5.3
where
40% modulus at 70° C. after the tensile test refers to a tensile stress at an elongation of 40% determined after extension of 50% at 70° C., releasing the stress, and then measuring the tensile stress at an elongation of 40% at 70° C. in accordance with JIS K 6251:2010; and
40% modulus at 70° C. before a tensile test refers to a tensile stress at an elongation of 40% measured before the tensile test at 70° C. in accordance with JIS K 6251:2010.

10. The tire according to claim 7,
wherein the 40% modulus (MPa) at 70° C. before a tensile test and the 40% modulus (MPa) at 70° C. after the tensile test of the rubber composition and a groove depth D (mm) of a circumferential groove on the tread satisfy the following formula:
[(40% modulus at 70° C. after tensile test/40% modulus at 70° C. before tensile test)/D]×100≥8.0
where
40% modulus at 70° C. after the tensile test refers to a tensile stress at an elongation of 40% determined after extension of 50% at 70° C., releasing the stress, and then measuring the tensile stress at an elongation of 40% at 70° C. in accordance with JIS K 6251:2010; and
40% modulus at 70° C. before a tensile test refers to a tensile stress at an elongation of 40% measured before the tensile test at 70° C. in accordance with JIS K 6251:2010.

11. The tire according to claim 7,
wherein the 40% modulus (MPa) at 70° C. before a tensile test and the 40% modulus (MPa) at 70° C. after the tensile test of the rubber composition and a negative ratio S (%) of the tread satisfy the following formula:
[(40% modulus at 70° C. after tensile test/40% modulus at 70° C. before tensile test)/S]×100≥2.0
where
40% modulus at 70° C. after the tensile test refers to a tensile stress at an elongation of 40% determined after extension of 50% at 70° C., releasing the stress, and then measuring the tensile stress at an elongation of 40% at 70° C. in accordance with JIS K 6251:2010; and
40% modulus at 70° C. before a tensile test refers to a tensile stress at an elongation of 40% measured before the tensile test at 70° C. in accordance with JIS K 6251:2010.
